(19) United States
(12) Patent Application Publication
(10) Pub. No.: US 2013/0142566 A1
(43) Pub. Date: Jun. 6, 2013

(54) ELECTROCHEMICAL METHODS FOR WIRE BONDING

(71) Applicant: Min-Feng Yu, Norcross, GA (US)

(72) Inventor: Min-Feng Yu, Norcross, GA (US)

(21) Appl. No.: 13/702,799

(22) PCT Filed: Jun. 8, 2011
(86) PCT No.: PCT/US11/39647

§ 371 Date: Feb. 20, 2013

Related U.S. Application Data
(60) Provisional application No. 61/352,590, filed on Jun. 8, 2010.

(51) Int. Cl. H01R 43/02

(52) U.S. Cl. CPC H01R 43/0235
USPC 403/271; 205/114; 204/275.1

(57) ABSTRACT

Probe-based methods are provided for wire bonding and joining of structures. The wire bonds are formed via a meniscus-confined electrodeposition technique. The electrodeposition technique of the invention can also be used for fabricating one or more nano-sized or micro-sized elongated structures. The structures extend at least partially upwards from the surface of a substrate, and may extend fully upward from the substrate surface. Apparatus suitable for use with the electrodeposition technique are also provided.

### CROSS REFERENCE TO RELATED APPLICATIONS

This application claims the benefit of U.S. Provisional Application No. 61/352,590, filed Jun. 8, 2010, which is hereby incorporated by reference in its entirety.

### BACKGROUND

With the ever-increasing device density in electronic chips, the density of interconnects and the complexity involved in the design of interconnects grow exponentially. Moreover, with the introduction of the 3-D chip, while the inter-chip vias technology(1) offers a viable solution to integrate devices in 3-D stacks, alternative interconnect technologies that can provide flexible means to electrically wire microscale device components in 3-D are still called for. As a traditional technology, the wire bonding technology has served the electronics industry for many decades, satisfying the interconnection needs for device packaging(2). Recently, to increase the interconnect density and improve device performance for high frequency operation, the flip-chip interconnect technology has been introduced(3). However, such practiced packaging technologies have difficulties in downscaling to very fine interconnect pad pitches (may need to be 1-5 μm in the near future). For instance, the thermo-sonic gold wire bonding has a limiting pitch of ˜40 μm, and the flip-chip technology ˜100 μm. This increases the on-chip space needed for the interconnect pads, reduces the number of chips that can be produced per wafer and consequently increases the cost per chip. Furthermore, it is expected that downscaling the traditional solder-based interconnect cannot meet the thermomechanical reliability requirement as well as the current density requirement at very fine pitches(4). .

Alternatively, among the 3-D microfabrication technologies that are compatible with electronic devices, e-beam or focused ion beam-based deposition (5) and direct-writing with metal colloidal ink(6) have been explored to fabricate 3-D interconnects with nanoscale or microscale dimensions. The e-beam or focused ion beam-based deposition is capable of fabricating 3-D structures having feature sizes down to ˜10 nm. However, the process must be performed in a high vacuum environment and the throughput is low. The choice of materials that can be deposited is limited by the limited availability of the special chemical compounds for this intended purpose and the deposited metals tend to have low electrical quality(5). Most recently, the direct-writing with metal colloidal ink has demonstrated the fabrication of ˜10 μm diameter interconnect bridges made of Ag with the use of an Ag colloidal dispersion and shown the promise of its potential application in electronic industry(6). The limitation, however, lies in the further downsizing of the fabricated wires: the fluidics involved with a colloidal dispersion ultimately limits the minimum nozzle size that can be used to disperse the colloidal dispersion due to the finite size of the colloidal particles in the dispersion. Further, a specific metallic colloidal material system has to be developed in order to fabricate a specific type of metallic wire while taking into consideration of how to eventually convert a colloidal wire fabricated from this process into a high quality metallic wire, for instance, through thermal annealing (6).

Due to the versatility of electrochemistry for plating and surface finishing of a wide range of materials, the principle of electrochemistry has recently been pursued and applied for the fabrication of various metallic nanostructures. For example, electrochemical deposition has been used to deposit large arrays of nanostructures in nanoporous templates, such as porous alumina or irradiated polymeric membranes (7-9). This template-based deposition can provide metal nanowires as small as 40 nm in diameter and a few micrometers in length (9).

In traditional probe-based electrochemical deposition a sharp conductive probe and a substrate are submerged in an electrolyte plating bath, and the localized electric field applied between the probe and the substrate induces local deposition when the probe is brought very close to the substrate (11, 12). The method has shown great potential as a fast and inexpensive way of fabricating arbitrary-shaped, high aspect ratio 3-D microstructures (e.g., columns and helices) on a wide range of conductive and semiconductive substrates. However, structures produced by this method can be porous and have feature sizes (such as diameters) in the tens of micrometers (12) due to the limitation in producing and maintaining a sharp conductive probe and in confining and maintaining the local electric field down to nanoscale dimensions. In addition, electrolyte bath-based deposition is not suitable for devices in which exposure to ionic solution needs to be avoided.

Iwata et al. report a technique of local metal plating using a scanning shear force microscope with a micropipet probe filled with an electrolyte solution (13). Both dots and lines of continuously formed dots were deposited along the surface of a substrate. The smallest dot width reported was 90 nm. The electrochemical deposition was carried out by applying a constant voltage for the modification time under open-loop current control, and the deposited structures are simple surface patterns (dots or lines).

Iwata is also listed as the inventor of Japanese Patent Publication No. 2005-349346, which relates to a method of depositing a micro-substance on a substrate. As described in the English abstract, the method involves a micropipet filled with a liquid containing a charged microsubstance and having an electrode inserted into its interior. An electric field is applied between the electrode and the substrate, resulting in the deposition of the microsubstance on the substrate surface due to the electric field induced physical diffusion of the microsubstance. In addition, Iwata is listed as the inventor of Japanese Patent Publication No.2005-349487, which reports a fine processing method and device in which a voltage is applied between a working fluid and a workpiece using a combination of a scan type shear force microscope and a hollow probe.

Japanese Patent Publication No. JP9251979 reports a minute working device for supplying a local area on a minute solid surface with a fluid without damaging the solid surface.

US Patent Application Publication 2009-0000362-A1, A. P. Suryavanshi, M.-F. Yu, Appl. Phys. Lett. 88, 083103 (2006) and A. P. Suryavanshi, M.-F. Yu, Nanotechnology 18, 105305 (2007) all of which are hereby incorporated by reference, describes an electrodeposition platform for nanostructure fabrication in which a stable liquid meniscus is used to obtain continuous growth of uniform-diameter micro- and nano-structures out of the substrate surface plane (14, 15).

### BRIEF SUMMARY

In one aspect, the invention provides electrochemical probe-based methods for forming high structural and electrical quality wires or other elongated structures confined and defined by the interface physics of a nanoscale or microscale liquid bridge (meniscus). These structures may be nano-sized or micro-sized in the lateral dimension with uniform diameter and smooth surface morphology. The direct-writing wire forming technology of the present invention is capable of operation in an ambient or controlled humidity air environment (thus avoiding subjecting the whole sample substrate to an electrolyte solution). These wire-like structures extend at least partially upwards from the surface of a substrate.

In an embodiment, the invention provides electrochemical probe-based methods for wire bonding. In an embodiment, the methods of the invention allow downsizing of the interconnect wire diameter to less than 1 μm and the bond size to below 3 μm, both an order of magnitude smaller than those in the current practice. The interconnect breakdown current density can be over 10¹¹ A/m².

The methods of the invention are not limited only to fabricating interconnect bridges with significantly reduced sizes and improved electrical and mechanical qualities that can potentially meet the challenges in electronics industry. As it is intrinsically an 3-D micro and nanofabrication technology, with the proper mechanical design and system control, it can be utilized to fabricate more intricate microscale and nanoscale structures of designed structural and device functionalities integrating a variety of metallic materials, such as magnetic and noble metals and even metal alloys. Moreover, as it is intrinsically a low cost direct-writing technology, this technique can be used to fabricate such micro-/nano-structures on existing micro-/nano-structures, which would otherwise be very difficult or expensive to fabricate with a traditional lithography process

In another embodiment, the invention provides electrochemical probe-based methods for joining wires or other elongated structures. These methods may be used to form a variety of structures, including nanoscale thermocouples made by joining two metal nanowires of dissimilar chemical composition, the nanowires may be deposited with the methods of the invention.

The methods of the invention also allow the formation of complex three-dimensional (3-D) nanoscale and microscale structures such as coil antennas. Nanoscale or microscale coil antennas can be used for microwave transmission and plasmonics. Other structures which can be formed with the methods of the invention include zigzag antennas, meander antennas, and loop antennas.

The methods of the invention can form structure(s) of a selected material through an electrodeposition process termed electrochemical fountain pen nanofabrication or meniscus-confined 3-D deposition. In the electrodeposition process, an external electric current is applied to an electrolytic cell formed by two electrodes in contact with an electrolyte solution.

In an embodiment, the meniscus-confined 3-D electrodeposition utilizes an electrolyte-containing reservoir such as a micropipette with a microscopic/nanoscopic dispensing nozzle as the working toolbit (as illustrated schematically in FIG. 1). The nozzle can be from several micrometers down to 100 nm in diameter. As the electrolyte reservoir approaches a conductive substrate surface to a close proximity, a meniscus (a liquid bridge) is established between the dispensing nozzle (element 12 in FIG. 1) and the substrate surface (element 40 in FIG. 1). The meniscus therefore confines a volume of electrolyte between the reservoir and the substrate surface. With an appropriate electrical potential applied between the electrolyte contained in the reservoir and the substrate surface, local electrodeposition on the substrate surface is initiated through this volume of electrolyte.

In an embodiment, the withdrawal speed of the reservoir and the electrochemical deposition parameters are selected together to form a stable meniscus between the nozzle of a given electrolyte reservoir and the electrodeposited structure that is preserved throughout the whole wire electrodeposition process. In FIG. 1, after initial electrodeposition the meniscus (32) is preserved between nozzle (12) and wire (50). For example, by the choice of an appropriate withdrawal speed of the reservoir defined by the dynamic stability of meniscus and the electrochemistry involved in the deposition, a stable meniscus formation can be maintained between the nozzle and the growth front of the electrodeposited structure. It has been found that selection of such an appropriate withdrawal speed can allow continuous growth of the off-surface micro-/nano-wires of high surface quality and uniform diameter to be realized and sustained.

In the off-surface growth methods of the invention, immediately after the initial electrodeposition on the substrate surface at the very beginning of the process the substrate surface no longer serves as a wetting surface for the meniscus. The methods of the invention thus contrast with electrochemical dip pen lithography in which the deposition is limited to surface patterning (16). The methods of the invention also differ from local metal plating with a micropipette probe, in which only microscale/nanoscale dots or lines patterned on surface are produced, as described by Iwata et al. (13). The methods of the invention are also different from electric field enhanced electrodeposition with a sharpened metal tip, in which the local electrodeposition is realized through the confinement of the electric field near the end of the tip (the confinement is thus not absolutely local) and the fabrication is performed with both the work piece and the tip immersed in an electrolyte environment (11).

In an embodiment, movement of the electrolyte reservoir with respect to the substrate is determined by the thermodynamic stability of the meniscus and the electrochemistry. The remarkable dexterity of the methods of the invention relies on the stability of the meniscus being maintained during the continuous deposition process. In general, the stability of the meniscus for this continuous electrodeposition of a substantially uniform diameter wire is influenced by wetting conditions involved with the nozzle and the wire growth front.

The size and shape of the meniscus formed between the nozzle and the growing electrodeposited structure (e.g. a wire) is believed to be defined by the size and shape of the nozzle and the thermodynamic properties of the liquid solution and the involved interfaces, and additionally by the separation between the nozzle and the growth front of the electrodeposited structure (thus the withdrawal speed of the micropipette and the growth rate of the structure). FIG. 2 illustrates meniscus formation (32) between the nozzle (12) of an electrolyte reservoir and an electrodeposited wire (50). Also shown are the diameter of the nozzle (D_{N}) (illustrated here as the inner diameter of the reservoir), the diameter of the wire (D_{W}) and the height of the meniscus (H_{M}). Theoretically, a meniscus as narrow as ˜2 nm can be established(21). Indeed, the mechanical and thermodynamic stability of such small meniscus has recently been extensively studied both experimentally and theoretically (22, 23). Relevant to this meniscus-confined 3-D electrodeposition, as the size of the meniscus defines the diameter of the deposited wire when a stable growth is established, this method is intrinsically capable of fabricating wires from microscale down to nanometer sizes. Practically, the mechanical stability of the physical system, the availability of nozzles of small sizes, the ion transport behavior through small nozzles and the electrochemical process in a confined meniscus environment may ultimately determine the minimum feature size of wires that can be fabricated with this method.

Dynamic stability and plasticity of the meniscus affords a robust process which allowed fabrication of high quality uniform-diameter micro- and Nano-wires and interconnect bridges as demonstrated herein. The processes of the invention are capable of avoiding the growth of stacked wires which are made of sequentially formed electrodeposited “dots” which are not substantially uniform in diameter stacked onto each other. Such stacked wires formed through a non-continuous deposition process are non-uniform in diameter and rough in surface finish.

The electrodeposition process may use a control system. The process control system may be connected to a device which measures the electrical current in the system. The process control system may also be connected to at least one motion control device. As illustrated in FIG. 1, the control system may be connected to a high sensitivity electrometer circuit which monitors and controls the ionic current in the pico-ampere to nano-ampere range. The control system is also shown in communication with positioning elements. A plurality of high precision actuators capable of providing nanometer displacement resolution and smooth motion (shown as x-y and z piezostages in FIG. 1) may be used to position the electrolyte reservoir with respect to the sample substrate.

In one aspect, the invention provides and employs an electrolyte reservoir whose end is shaped to allow off-substrate electrodeposition of structures where at least a portion of the longitudinal axis of the structure is parallel to or nearly parallel to a plane of a substrate or perpendicular to or nearly perpendicular to the longitudinal axis of the dispensing end of the reservoir. A direction parallel to the substrate may also be referred to as a lateral direction, while the direction perpendicular to the substrate may be referred to the vertical direction. In different embodiments, the longitudinal axis of the structure is nearly perpendicular to the longitudinal axis of the dispensing end if the angle between the longitudinal axis of the structure and the longitudinal axis of the wire is within 10° or within 5° of being perpendicular to the longitudinal axis of the dispensing end. Alternately, the longitudinal axis of the structure may be nearly parallel to a plane of the substrate (e.g. a plane passing through the attachment point) if the longitudinal axis of the wire is within 10° or within 5° of being parallel to the plane of the substrate. Typically the electrolyte reservoir comprises a peripheral structure surrounding an aperture. In an embodiment, the peripheral structure of the dispensing end of the electrolyte reservoir may comprise one opening, gap or notch or more than one such structure; exemplary structures are illustrated in FIGS. 3a-b. In another embodiment, the dispensing end of the reservoir may comprise a supported central member which is located within the peripheral structure and having a free end which projects beyond the peripheral structure; an exemplary structure is illustrated in FIG. 6. It has been found that dispensing ends in the form of a simple hollow cylinder or a simple graduated or tapered hollow cylinder are not preferred for electrodeposition of structures parallel or nearly parallel to the plane of the substrate.

In an embodiment, the dispensing end is shaped to allow formation of a dynamically-stable meniscus which is not symmetrical about the longitudinal axis of the reservoir. Formation of such a meniscus can facilitate growth which is not aligned with the longitudinal axis of the nozzle or reservoir. The peripheral portion of the dispensing end may be in the form of a hollow cylinder or graduated (tapered) hollow cylinder containing a notch or side opening. FIG. 3a shows a side view of a shaped micropipette nozzle having a nozzle diameter of approximately 3 μm; the nozzle was shaped by forming a notch or side opening in a generally cylindrical micropipette; the notch extends through the thickness of the side wall of the micropipette to create a side opening. In an embodiment, the inclusion of a side opening or notch at the nozzle end (dispensing end) of a reservoir can allow the formation of a stable meniscus with at least a portion of the electrodeposited wire oriented along any direction from 0° (parallel) to 90° (normal) with respect to the substrate surface. In an embodiment, this type of nozzle shape may be viewed as having a notch length (l1) and a notch height (h), with the notch length being measured along the top of the notch on the external surface of the reservoir as schematically illustrated in FIG. 3b. In different embodiments, the notch length l1 may be greater than zero and less than the circumference of the nozzle, greater than zero and less than or equal to one half the circumference of the nozzle, or from 0.1 to 0.4 times the circumference of the nozzle (as measured at the top of the notch). In different embodiments, h is greater than zero and less than 5 microns, greater than zero and less than or equal to 1.5 OD (OD being the outer diameter of the nozzle at the exit end), greater than zero and less than or equal to 1.0 OD, from 0.1 OD to 1.5 OD , from 0.5 OD to 1.5 OD, or from 0.5 OD to 1.0 OD, greater than zero and less than or equal to 1.5 ID (ID being the inner diameter of the nozzle at the exit end, greater than zero and less than or equal to 1.0 ID, from 0.1 ID to 1.5 ID, from 0.5 ID to 1.5 ID, or from 0.5 ID to 1.0 ID. In an embodiment, when the notch length is less than or equal to the one half the circumference of the nozzle, the notch may also be characterized by a width which can be defined as the minimum distance between the side walls of the notch at a given height. For a nozzle having a hollow generally circular cylindrical shape (except for the notch) and notch side walls which are generally parallel to the longitudinal axis of the nozzle, the width of the notch is the length of the chord between the side walls of the notch . In different embodiments, the notch width may be from 0.1 OD to 1.0 OD, from 0.1 OD to 0.75 OD, or from 0.2 OD to 0.5 OD, 0.1 ID to 1.0 ID, from 0.1 ID to 0.75 ID, or from 0.2 ID to 0.5 ID. The notch illustrated in FIG. 3a has a side walls which are generally parallel to the longitudinal axis of the nozzle and top wall which is generally perpendicular to the side walls. Useful notches may also have other shapes, such as a beveled shape. The shaping of the nozzle may be done with focused ion beam based machining, which provides the precision needed to cut out such a micro-sized glass structure. FIG. 4 shows a series of angled Cu wires grown with such a side-cut nozzle. The vertical and lateral lengths as well as the orientation of the Cu wires were controlled by the travel path of the micropipette, and the diameter determined by the nozzle size and the size of the side opening in the nozzle. Further details are given in Example 1.

FIGS. 5a and 5b show schematic perspective and side views, respectively of another nozzle design, termed the omni-directional configuration. Such a design can allow the formation of a stable meniscus with an electrodeposited wire oriented along a variety of directions (all lateral directions as well as the vertical direction). In this design, the aperture is generally circular and spanned by a support or dividing member (70). One end of a central member or post (75) connects to this support or dividing member and the other end of the central member or post projects forwards of the peripheral portion of the nozzle surrounding the aperture. The peripheral portion of the dispensing end may be in the form of a hollow cylinder or graduated (tapered) hollow cylinder. This configuration can be manufactured using a compartmentalized tube with a central septum (theta tube), as described in Example 4. In an embodiment, the height (H) of the post is greater than zero and less than or equal to the OD (the outer diameter of the micropipette at the exit end). In other embodiments, the height of the central member may be from 0.1 to 1.0 times, 0.25 to 1.0 times or from 0.5 to 1.0 times the outer diameter of the dispensing end of the reservoir.

In an embodiment, the invention provides probe-based methods for formation of one or more elongated structures which extend at least partially upwards from the surface of a substrate. The methods of the invention allow control of the upwards extension or height of the structures. In different embodiments, the elongated structures are continuously grown and are nano-sized or micro-sized in the lateral dimension with uniform geometry and surface morphology. In different embodiments, the height of the structures can be greater than one micrometer or greater than 5 micrometers.

Such high quality nano-sized or micro-sized structures in the form of nanowires can be used as interconnects for electronic packaging and/or repair, and as nanoprobes for electronic testing and chemical sensing. The methods of the invention also allow the formation of complex three-dimensional (3-D) structures such as microcoil antennas or inductors. Nano-scale or micro-scale coil antennas and inductors can be used for microwave transmission and plasmonics. The methods of the invention also allow fabrication of freestanding nanowire or micro-sized wire arrays. The diameter of the wires used to form these structures may be from 0.1 to 10 micrometers, from 0.1 to 7.5 micrometers, from 0.1 to 5 micrometers, from 0.1 to 1 micrometer, or of other dimensions

In an embodiment the invention provides a method for forming an elongated structure of a selected material, the structure extending at least partially upwards from the surface of an electrically conducting substrate, the method comprising the steps of:
a. providing an electrolyte reservoir having a dispensing end, the dispensing end comprising a peripheral structure surrounding an aperture, the dispensing end being shaped to allow off-substrate wire formation in a lateral or nearly lateral direction (in a plane parallel to or nearly parallel to that of the surface of the substrate), in a vertical direction (normal to that of the surface of the substrate) and directions in between lateral and vertical directions, the size of the aperture being less than or equal to 10 micrometers, the reservoir containing
   i. an electrolyte solution comprising at least one active ionic component; and
   ii. a reservoir electrode in electrical contact with the electrolyte solution
b) applying a potential difference between the reservoir electrode and the electrically conducting substrate such that the substrate serves as a cathode and the reservoir electrode as an anode;
c) bringing the aperture of the electrolyte reservoir to a first position sufficiently close to substrate to establish a meniscus between the dispensing end of the reservoir and the substrate, thereby establishing a volume of electrolyte solution external to the reservoir between the dispensing end of the reservoir and substrate, and sufficiently close to establish an ionic current between the reservoir electrode and the substrate, thereby reducing the electrochemical active ionic component in the electrolyte to electrodeposit the selected material at the substrate;
d) selecting a trajectory for moving the electrolyte reservoir from the first position to a second position, the trajectory having both a lateral and a vertical component with respect to the substrate;
e) moving the reservoir along the first trajectory at a speed selected to maintain a stable meniscus between the moving dispensing end of the reservoir and the growing electrodeposited material, thereby sustaining a continuous electrodeposition to grow a wire of the selected material following the trajectory.
   In an embodiment, the wire has a substantially smooth surface finish, a substantially nonporous structural nature and a substantially uniform diameter (uniform to within +/−15%, +/−10%, or +/−5% above the base portion). The diameter may be from 0.1 to 10 micrometers, from 0.1 to 7.5 micrometers , from 0.1 to 5 micrometers, from 0.1 to 1 micrometer, or of other dimensions. The electrolyte reservoir may have a notch or side opening at the dispensing end or may have a supported central member which projects beyond the peripheral structure at the dispensing end. The size of the aperture may be from 0.1 to 10 micrometers, from 0.1 to 1 micrometer, from 0.5 to 7.5 micrometers or of other dimensions. In an embodiment, the reservoir is moved at a speed from 50 nm/s to 500 nm/s. Both the speed and the applied potential different may be constant within 15%, 10%, 5% or 2%.

In another embodiment, the invention provides a method for forming a wire bond between a first and a second contact site. Both the first and second contact sites may be located on the surface of an electronic device (e.g. a semiconductor device). For example, one of the contact sites may be located on a pad of a semiconductor die and the other contact site may be located on the pad of another semiconductor die or on a contact lead.

In an embodiment, the method comprises the step of electrodepositing a micro-sized or nano-sized wire at the first contact site. The wire is electrically connected to the first contact site. In an embodiment, the wire is formed so that it initially extends from the first contact site to a location vertically above the second contact site. In an embodiment, the wire is first formed vertically (perpendicular to the substrate at the first contact site) and then transitioned to lateral formation, as illustrated in FIGS. 6a-b. However, other initial wire shapes may also be used. For example, a “tilted” wire may be formed (angle with respect to plane of substrate less than 90 degrees and greater than zero degrees) followed by lateral formation or wire formation at a smaller angle than the previous angle. The wire may be formed by moving the electrolyte reservoir along a preselected first trajectory from the first position (initial position for electrodeposition) to a second position above the second contact site, the first trajectory having both a lateral and a vertical component with respect to the first contact site. In an embodiment, the second contact site is located on a plane that is either the same as that of the first contact site or located on a plane that is vertically above that of the first contact site. In order to form wires of the desired shape, the dispensing end of the electrolyte reservoir may be shaped to allow wire formation where at least a portion of the wire axis is perpendicular to the longitudinal axis of the reservoir. In different embodiments, the electrolyte reservoir may have a notch or side opening at the dispensing end or may have a supported central member which projects beyond the peripheral structure. In an embodiment, the reservoir is moved at a speed from 50 nm to 500 nm/sec.

The “free” end of the wire (the end not attached to the substrate) may then be lodged onto the notch on the side of the micropipette or under the tip of the micropipette and be pushed down towards the second contact site so that the free end of the wire is close to, but not fully touching the second contact site, as illustrated in FIG. 6c. This step may be accomplished by moving the electrolyte reservoir along a preselected second trajectory from the second position to a third position just above the second contact site. The third position is sufficiently close to the second contact site to establish a meniscus between the dispensing end of the reservoir and the second contact site. The location of the third position may be predetermined immediately after the end of the lateral wire growth and before pushing the free end of the wire. In this case, the micropipette is moved laterally slightly away from the free end of the wire to break the meniscus between the electrolyte reservoir and the free end of the wire, and the electrolyte reservoir is moved towards the second contact site until a meniscus is formed. This meniscus formation can be detected from the measured ionic current and the location of the third position can be determined from the required motion of the positioning stages. The reservoir is then moved back up to lodge the free end of the wire to execute the second bond formation process as described above.

Subsequent electrodeposition is used to join this end of the wire to the second contact site (as in FIG. 7d). In an embodiment, a plurality of voltage pulses may be used to join the free end of the wire to the second contact site.

In an embodiment, the invention provides a method for forming a wire bond between a first and a second contact site, the wire of the bond being of a selected material, the method comprising the steps of:
a. providing an electrolyte reservoir having a dispensing end, the dispensing end comprising a peripheral structure surrounding an aperture, the dispensing end being shaped to allow wire formation in a lateral or nearly lateral direction (in a plane parallel or nearly parallel to that of the surface of the first contact site), in a vertical direction (normal to that of the surface of the first contact site) or any direction in between lateral and vertical directions with respect to the first contact site and, the size of the aperture being less than or equal to 10 micrometers, the reservoir containing
   i) an electrolyte solution comprising at least one ionic component; and
   ii) a reservoir electrode in electrical contact with the electrolyte solution;
b) applying a potential difference between the reservoir electrode and a first contact site, such that the first contact site serves as a cathode and the reservoir electrode as an anode;
c) bringing the aperture of the electrolyte reservoir to a first position sufficiently close to the first contact site to establish a meniscus (a liquid bridge) between the dispensing end of the reservoir and the first contact site, thereby establishing a volume of electrolyte solution external to the reservoir between the dispensing end of the reservoir and the first contact site, and to establish an ionic current between the reservoir electrode and the first contact site, thereby reducing the ionic component in the electrolyte to electrodeposit the selected material at the first contact site;
d) selecting a first trajectory for moving the electrolyte reservoir from the first position to a second position directly above the second contact site, the first trajectory having both a lateral and a vertical component with respect to the first contact site;
e) moving the reservoir along the first trajectory at a speed selected to maintain the meniscus formation between the moving dispensing end of the reservoir and the growing electrodeposited material, thereby sustaining continuous electrodeposition to grow a wire of the selected material following the first trajectory;
f) contacting the wire with the dispensing end of the reservoir;
g) selecting a second trajectory for moving the electrolyte reservoir from the second position to a third position sufficiently close to the second contact site to establish a meniscus between the dispensing end of the reservoir and the second contact site;
h) moving the reservoir along the second trajectory while maintaining physical contact between the wire and the dispensing end, thereby pushing the wire towards the second contact site;
i) forming a meniscus between the dispensing end of the reservoir and the second contact site, thereby forming a volume of electrolyte solution external to the reservoir between the dispensing end of the reservoir and the second contact site, wherein the wire is in contact with this volume of electrolyte solution but not in contact with the second contact site;
j) applying a potential difference between the reservoir electrode and the second contact site so that the second contact site serves as a cathode and the reservoir electrode as an anode, thereby reducing the ionic component in the electrolyte and electrodeposit the selected material at the second contact site and joining or fusing the wire to the second contact site.
   In an embodiment, the wire has a substantially smooth surface finish, a substantially nonporous structural nature and a substantially uniform diameter (uniform to within +/−15%, +/−10%, or +/−5% in the central portion of the wire bond between first and second end regions at the first and second contact sites). The diameter may be from 0.1 to 10 micrometers, from 0.1 to 7.5 micrometers from 0.1 to 5 micrometers, from 0.1 to 1 micrometer, or of other dimensions. The electrolyte reservoir may have a notch or side opening at the dispensing end or may have a supported central member which projects beyond the peripheral structure at the dispensing end. The size of the aperture may be from 0.1 to 10 micrometers, from 0.1 to 1 micrometer, from 0.5 to 7.5 micrometers or of other dimensions. In an embodiment, the reservoir is moved at a speed from 50 nm/s to 500 nm/s. Both the speed and the applied potential different may be constant within 15%, 10%, 5% or 2%.

In another embodiment, the invention also provides a metallic wire bond between a first and a second contact point, wherein the wire bond comprises:
a) a central portion, the central portion having a diameter which is uniform to within +/−15%, +/−10%, or +/−5%, the average diameter in the central portion being from 100 nm to 10 micron;
b) a first end portion connected to one end of the central portion and to the first contact point, wherein the diameter of the first end portion generally decreases from 1 to 5 times the diameter of the central portion at the first contact point to the diameter of the central portion at the connection to the central portion, the length of the first end portion being from 1 to 20 times the diameter of the central portion;
c) a second end portion connected to the other end of the central portion and to the second contact point, wherein the average diameter of the second end portion is larger than the diameter of the central portion and the height of the second end portion is from 1 to 3 times the diameter of the central portion.
   In different embodiments, the diameter in the central portion may be from 0.1 to 10 micrometers, from 0.1 to 7.5 micrometers, from 0.1 to 5 micrometers, from 0.1 to 1 micrometer, or of other dimensions. The average diameter of the first and second end portion may be from 2 to 5 times the diameter of the central portion. In an embodiment, the average diameter of each of the first and second end portions is less than 3 micrometers. The wire bond may comprise copper, gold, platinum, palladium, or alloys thereof

In another embodiment, the invention also provides an electronic or semiconductor device comprising a metallic wire bond according to the present invention.

The methods of the invention may also be used to connect the free end of two wires, for example to form a micro-size or nano-sized thermocouple, by assuming the end of the other wire as the second contact site in the wire bonding process.

In one aspect of the invention, the substrate may be a structure such as a scanning probe microscopy tip or microelectrode and the methods of the invention may be used to form a fine extension of the original structure. In an embodiment, the invention provides a method for making a modified scanning probe microscopy probe which comprises a nanowire attached to the probe tip. The invention also provides scanning probe microscopy probes made by the methods of the invention. Such conductive probes with high aspect ratios are useful for critical metrology imaging and nanoscale electrical probing applications.

In another embodiment, the invention provides a method for forming an electrically conducting probe which comprises a conductive nano or micro-sized wire extending out from a conductive wire of larger diameter. The invention also provides electrically conducting probes made by the methods of the invention. Such electrodes can be used for biological and cellular probing, where the nano-sized or micro-sized wire can be used to penetrate through the cell membrane, and to apply electric pulses and measure electrochemical potentials in local nanoscale environments

In another aspect, the invention provides electrolyte reservoirs with specially designed apertures which allow both lateral and vertical electrodeposition. In an embodiment, the invention provides an electrolyte reservoir comprising a dispensing end having a longitudinal axis and comprising a peripheral portion surrounding an aperture, the peripheral portion being in the form of a hollow cylinder or a hollow graduated cylinder including a notch, wherein the outer diameter of the cylinder at the dispensing end is from 500 nanometers to 10 micrometers, the height of the notch is from 0.1 to 1.5 times the cylinder outer diameter, and the minimum width of the notch is from 0.1 to 0.75 times the cylinder outer diameter. In additional embodiments, the outer diameter of the cylinder at the dispensing end may be 250 nm to 10 micrometers, 500 nm to 5 micrometers, or 500 nm to 2 micrometers.

In another embodiment, the invention provides an electrolyte reservoir comprising a dispensing end having a longitudinal axis, the dispensing end comprising
a) a peripheral portion surrounding an aperture, the peripheral portion being in the form of a hollow or graduated hollow cylinder
b) a support member at least partially spanning the aperture; and
c) a central member having a height (H) and being connected to the support member at a first end, the other end of the central member extending beyond at least a portion of the peripheral portion of the dispending end
wherein the outer diameter of the cylinder is from 500 nanometers to 10 micrometers and the height of the central member is less than or equal to the outer diameter of the cylinder.
   In additional embodiments, the outer diameter of the cylinder at the dispensing end may be 250 nm to 10 micrometers, 500 nm to 5 micrometers, or 500 nm to 2 micrometers. In different embodiments, the height of the central member may be from 0.25 to 1.0 times the outer diameter or from 0.5 to 1.0 times the outer diameter.

In another aspect, the invention provides an apparatus employing the electrolyte reservoirs of the invention. In an embodiment, the invention provides an apparatus for electrodeposition of an elongated structure extending at least partially upwards from the surface of a substrate, the apparatus comprising:
a. an electrolyte reservoir of the invention having a first and a second openings, the first opening having an aperture size less than or equal to 10 micrometers;
b. a reservoir electrode located at least partially within the electrolyte reservoir;
c. a source of electrical potential connected between the reservoir electrode and the substrate;
d. an electrical current measuring device capable of measuring the current between the reservoir electrode and the substrate;
e. a mechanical motion system capable of providing precision (nanoscale resolution) motions in x-y-z directions.
f. a motion control device operably connected to control the motion of at least one of the electrolyte reservoir and the substrate; and
g. a process control system operably connected to both the electrical current measuring device and the motion control device.

### BRIEF DESCRIPTION OF THE DRAWINGS

FIG. 1: Schematic showing the general setup for the meniscus-confined 3-D electrodeposition. The long travel range piezostages provide the fine positioning needed for controlling the travel path of the micropipette in the 3-D space. The high sensitivity electrometer circuit monitors and controls the ionic current. A magnified view at the nozzle/metal wire interface (right) shows the formation of a meniscus (a liquid bridge) serving as the stable confinement for the continuous electrodeposition of a uniform diameter microscale/nanoscale metal wire as the micropipette is continuously withdrawn from the substrate surface.

FIG. 2: Schematic showing the meniscus and the angle between the growth direction and the slope of the meniscus at the three phase contact line relevant to the stable electrodeposition of uniform diameter metal wires.

FIG. 3a: SEM image showing the nozzle at the end of a glass micropipette with a side cut made with the focused ion beam based machining; labels have been added to indicate the height (h) of the side cut.

FIG. 3b: Schematic showing another external view of the dispensing end of a reservoir with a side cut having a depth less than the radius of the reservoir; this view shows the width (l1) of the side cut as well as the height (h) and the external diameter (OD) of at the exit of the reservoir.

FIG. 4: Electrodeposited Cu wires with different inclination angles fabricated with the use of a side-cut micropipette.

FIGS. 5a-b: (a) Schematic perspective view of omni-directional nozzle design. (b) Schematic side view of omni-directional nozzle design.

FIG. 6: Schematic showing the steps involved in a wire bonding process with meniscus-confined 3-D electrodeposition.

FIGS. 7a-c: Schematics showing two different four probe atomic force microscope (AFM) probe configurations (a-b) and a thermocouple AFM probe configuration (c).

FIGS. 8a-b: Meniscus stability defined parameter window for the stable electrodeposition of uniform diameter metal wires. (a) Dependence of wire diameter on the withdrawal speed of the micropipette at a fixed ionic current of ˜12 nA with the use of a micropipette having a nozzle diameter of ˜1.6 μm. (b) Dependence of wire diameter on the ionic current at a fixed withdrawal speed of ˜0.3 μm/s with the use of the same pipette. In the plot, the experimental data are labeled with the symbol o and the modeling data with a solid line

FIGS. 9A-D: Meniscus-confined electrodeposition for the fabrication of 3-D structures and needle probes with regular micropipette without a micromachining-shaped nozzle. (A) SEM image showing the side view of a Cu coil having a wire diameter of ˜1.6 μm, a coil diameter of ˜7 μm and a pitch of ˜17 μm fabricated with the use of a micropipette having a nominal nozzle diameter of ˜2 μm. (B) SEM image showing the top view of the same Cu coil in (A). (C) SEM image showing the side view of a Cu coil having a wire diameter of ˜300 nm, a coil diameter of ˜800 nm and a pitch of ˜3.8 μm. (D) SEM image showing a Pt needle directed deposited on the apex of an atomic force microscope probe tip. The Pt needle has a diameter of ˜80 nm and a length of ˜1.2 μm.

FIG. 10: (a) SEM image showing 20 electrodeposited interconnects having sub-micron diameters fanning out from a central pad of 50 μm×50 μm in size. (b) SEM image showing the uniform quality of the first and the second bonds. (c) SEM image showing the multilayered interconnection over three steps of 5 μm each in height. (d) SEM image showing the overlap interconnects over steps of 5 μm in height. The scale bar in the images is 10 μm.

FIG. 11: Constant current mode I-V characteristics of a Cu interconnect (˜740 nm in diameter and ˜40 μm in length) showing the linear Ohmic contact behavior of the bonds measured in an ambient air environment. The inset shows the failed wire at high current.

FIGS. 12A-C: Fabrication and characterization of a Pt interconnect. (A) SEM image showing a Pt interconnect fabricated with the meniscus-confined wire bonding process. The Pt wire has a diameter of ˜900 nm and a length of ˜30 μm. (B) SEM image showing the wire after the burn down at high current. (C) the acquired I-V characteristics from the bonded Pt wire showing the linear Ohmic behavior at low current and the nonlinear behavior at high current due to potentially heating effect.

FIGS. 13a-b: (a) Schematic showing a perspective view of a theta tube and its septum. (b) schematic showing a perspective view of a micropipette formed from the theta tube in (a).

FIGS. 14a-c: (a) Schematic showing the meniscus formed in the omni-directional nozzle. (b) SEM image showing a Cu coil fabricated with the omni-directional nozzle. (c) SEM image showing an array of Cu coils fabricated with the Omni-directional nozzle.

### DETAILED DESCRIPTION

In the drawings, like reference numbers are used to refer to like elements.

The methods of the invention can be used to form one or more nanostructures, also referred to as nano-sized structures. As formed, the nanostructures are attached to a substrate. As used herein, a nanostructure has at least one dimension in the range from 1 nm to 1000 nm. In an embodiment, the nanostructure is elongated, having a length (axial dimension) greater than its width (lateral dimension). In an embodiment, the lateral dimension (such as the diameter) is in the range from 1 nm to 1000 nm, from 1 nm to less than 1000 nm, from 50 nm to 750 nm, or from 50 to 500 nm, from 100 nm to less than 1000 nm, from 100 nm to 900 nm, from 100 nm to 750 nm, from 250 nm to less than 1000 nm, from 250 nm to 900 nm, from 250 nm to 750 nm, from 500 nm to less than 1000 nm, from 500 nm to 900 nm, or from 500 nm to 750 nm In an embodiment, the nanostructure is substantially nonporous and may have porosity from 0 to 5%, from 0 to 3% or from 0 to 1.5%. In an embodiment, the nanostructure is a nanowire of uniform diameter and smooth surface quality. As used herein, a wire is a solid elongated column-like structure. The nanowires of the invention may display some variation of lateral dimension or diameter along the length of the nanostructure. In another embodiment, the lateral dimension of the nanowire is substantially uniform (within +/−15%, +/−10%, or +/−5%). In an embodiment, the lateral dimension of the nanowire is substantially uniform above a base region (the base region will typically be of larger diameter). In an embodiment, the surface of the nanostructure is substantially smooth, having a low surface roughness. In an embodiment, the substantially smooth nanostructure surface has a roughness smaller than several nanometers, such as from 0 to 5 nm, 0 to 3 nm, or 0 to 1.5 nm. In an embodiment, the nanowire is broader at the substrate end than the free end. In different embodiments, the aspect ratio (ratio of length to diameter) of the nanowire is greater than 5, greater than 10 or greater than 100. A nanowire may be straight, bent or coiled.

The methods of the invention can also be used to form one or more micro- sized structures. As used herein, a micro-sized structure has at least one dimension in the range from 1 micron to 1000 micron. In an embodiment, the micro- sized structure is elongated and has a lateral dimension (such as a diameter) in the range from 1 micrometer to 10 micrometers, from 1 to 7.5 micrometers, or from 1 micrometer to 5 micrometers. In different embodiments, the micro-sized structure is a wire. In another embodiment, the lateral dimension of the micro-sized wire is substantially uniform (within +/−15%, +/−10%, or +/−5%). In an embodiment, the lateral dimension of the microwire is substantially uniform above a base region (the base region will typically be of larger diameter). In an embodiment, the surface of the micro-sized structure is substantially smooth, having a low surface roughness. In an embodiment, the substantially smooth surface has a roughness smaller than several nanometers, such as from 0 to 10 nm, 0 to 5 nm, or 0 to 3 nm.

In another embodiment, an electrodeposited wire may have a diameter from 50 nm to 10 micrometers, from 100 nm to 10 micrometers, from 250 nm to 10 micrometers, from 500 nm to 10 micrometers, from 100 nm to 7.5 micrometers, 250 nm to 7.5 micrometers, from 500 nm to 7.5 micrometers, from 100 nm to 5 micrometers, from 250 nm to 5 micrometers, from 500 nm to 5 micrometers from 100 nm to 2 micrometers, from 250 nm to 2 micrometers, from 500 nm to 2 micrometers, from 100 nm to 1 micrometer, from 250 nm to 1 micrometer, or from 500 nm to 1 micrometer. In another embodiment, the lateral dimension of the wire is substantially uniform (within +/−15%, +/−10%, or +/−5%). In an embodiment, the lateral dimension of the wire is substantially uniform above one or more base regions where the wire contacts the substrate (the base region will typically be of larger diameter). In an embodiment, the surface of the structure is substantially smooth, having a low surface roughness. In an embodiment, the substantially smooth has a roughness smaller than several nanometers, such as from 0 to 10 nm, 0 to 5 nm, or 0 to 3 nm.

The elongated structures of the invention extend at least partially or fully upwards or away from the surface of the substrate. As used herein, a structure extending at least partially upwards or away from the substrate extends at least partially in a direction perpendicular to the surface of the substrate (vertical or z direction). The structures of the invention differ from structures which are deposited solely or wholly on the surface of the substrate. In an embodiment, a structure of the invention extends upwards so that the height of the structure above the substrate surface is at least greater than the lateral dimension of the structure (e.g. the diameter of the structure). In other words, the longitudinal axis of each structure is oriented so that at least a portion of the longitudinal axis is not completely parallel to the surface of the substrate. In different embodiments, the height of the structure is greater than 100 nm, greater than 250 nm, greater than 500 nm, greater than one micrometer, or greater than 5 micrometers.

Structures provided by the invention include substantially straight nano or micro-sized wires whose longitudinal axes are substantially perpendicular to the surface of the substrate (where the structure is attached to the surface). Structures provided by the invention also include those whose longitudinal axes are neither parallel nor perpendicular to the surface of the substrate at the site of attachment of the structure. Structures of the invention also include curved or bent nano or micro-sized wires whose longitudinal axis has a varying orientation with respect to the surface of the substrate. For this type of structure, the longitudinal axis of at least a portion of the structure is not in a plane parallel to that of the substrate.

In an embodiment, the structure is a coil having a pitch from 0.5 micrometer to 100 micrometers. Other structures which can be formed with the methods of the invention include zigzag antennas, meander antennas, and loop antennas. In an embodiment, the structure is a zigzag antenna having a period from 1 micrometer to 20 micrometer. In an embodiment, the structure is a meander antenna having a period from 1 micrometer to 20 micrometers. In an embodiment, the structure is a loop antenna having a radius from 1 micrometer to 20 micrometer.

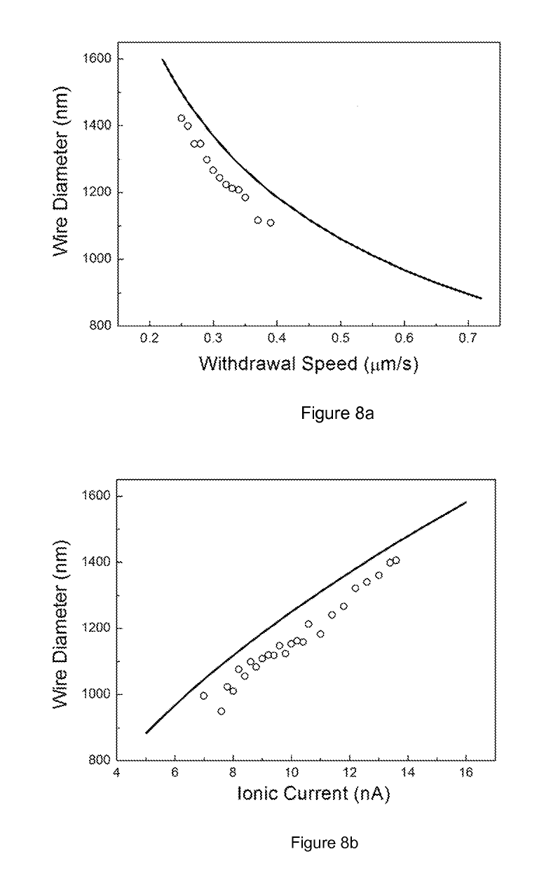

Assemblies of structures can also be formed. For example, FIGS. 7a-b show schematics of two different AFM probe configurations, each configuration including four structures made using the methods of the invention. The structures may be nanostructures. The structures can function as probes for microscale and submicroscale quantitative electrical and electronic characterization of materials and circuits. As another example, two or more metal wires can be formed and joined, as illustrated in FIG. 7c. Two dissimilar metal nanowires can be formed and joined to form a nanoscale thermocouple. Such a thermocouple can be integrated into an atomic force microscopy (AFM) probe for use in imaging and temperature sensing.

Structures provided by present invention are formed at least in part via an electrodeposition process. As used herein, electrodeposition is the process of depositing a material on a surface by the action of electric current. In the electrodeposition processes of the invention, an external electric current is applied to the electrolytic cell formed by two electrodes in contact with the electrolyte solution. One electrode is located in the interior of the electrolyte reservoir. The other electrode is initially formed by the substrate, but is later formed by the electrodeposited material. Both the substrate and the electrodeposited material have sufficient electrical conductivity (no smaller than 1 S/m) to enable the electrodeposition process to proceed.

Metal deposition can be achieved by putting a negative charge on the surface and contacting it with a solution which comprises positive ions of the metal to be deposited (in other words, the surface to be plated is made the cathode of an electrolytic cell). During the electrodeposition, the cathode, provides electrons to reduce the metal ions to solid metal. Suitable metals for deposition include, but are not limited to, copper, platinum, gold, palladium, cobalt, nickel, titanium, aluminum, niobium, silver, iridium, hafnium, tantalum, zirconium, yttrium, neodymium, and samarium. Metal alloys may also be deposited.

The methods of the invention can form one or more elongated structures through localized electrodeposition. Electrodeposition is localized through formation of an electrolyte meniscus between the surface on which deposition is to occur and the dispensing end of an electrolyte reservoir. This meniscus defines a volume of electrolyte between the dispensing end of the reservoir and the surface on which deposition is to occur. Without wishing to be bound by any particular theory, electrodeposition is believed to occur only on the portion of the surface in contact with this volume of liquid. As used herein, a meniscus is defined as the curved surface of a liquid with another fluid (which can be a gas or vapor), the meniscus being supported or bound by at least one solid surface. As used herein, a stable meniscus is a meniscus which remains intact (doesn't break) during any given electrodeposition stage. Typically, the stable meniscus of the invention remains intact during motion of at least one of its bounding surfaces (e.g. the portion of the pipette surrounding the aperture). During some portions of the electrodeposition process, two bounding surfaces are moving with respect to the initial point of electrodeposition: the portion of the electrolyte reservoir surrounding the aperture and the growth front of the electrodeposited material. The stable menisci of the methods of the present invention typically possess some dynamic stability and have the ability to recover from limited perturbations from steady state before breaking.

To form structures which extend at least partially upwards from the substrate, the electrolyte reservoir and the substrate are moved away from each other during the deposition process (for example, the electrolyte reservoir may be moved upwards with respect to the substrate). The separation may be increased in the vertical (z) direction, or increased in combinations of the z direction with the x and or y directions. In addition, after initial growth of the structure up from the substrate, the structure may bend back down towards the substrate.

In an embodiment, the size and shape of the meniscus formed between the nozzle and the growing metal wire is defined by the size of the nozzle and the thermodynamic properties of the liquid solution and the involved interfaces, and additionally by the separation between the nozzle and the growth front of the wire (thus the withdrawal speed of the micropipette and the growth rate of the wire). Theoretically, a meniscus as narrow as ˜2 nm can be established(21). Indeed, the mechanical and thermodynamic stability of such small meniscus has recently been extensively studied both experimentally and theoretically (22, 23). Relevant to this meniscus-confined 3-D electrodeposition, as the size of the meniscus defines the diameter of the deposited wire when a stable growth is established, this method is intrinsically capable of fabricating wires down to nanometer sizes. Practically, the mechanical stability of the physical system, the availability of nozzles of small sizes, the ion transport behavior through small nozzles and the electrochemical process in a confined meniscus environment may ultimately determine the minimum feature size of nanostructures that can be fabricated with this method.

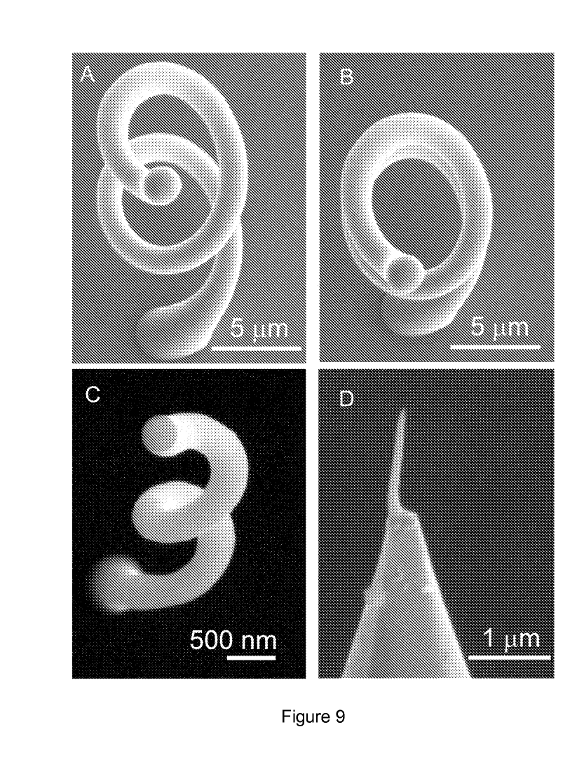

One method of modeling the relationship between meniscus parameters and parameters for growth of a cylindrical wire using a hollow cylindrical electrolyte reservoir is given in Example 3. FIGS. 8a and 8b show the experimentally acquired parameter window for the stable growth of a copper wire in terms of the resulting wire diameter, the withdrawal speed and the applied ionic current, in comparison to the prediction from the described model of Example 3.

In an embodiment, an electrical potential is applied between the reservoir electrode and the substrate before the dispensing end of the electrolyte reservoir is brought sufficiently close to the substrate surface to form the electrolyte meniscus. In an embodiment, the electrical potential is substantially constant during the electrodeposition process. The optimal potential may determined from the CV (cyclic voltammetry) measurement for the specific type of electrochemical reaction.

In an embodiment, the electrical current between the electrode in the electrolyte reservoir and the substrate is measured. As used herein, the term electrical current encompasses flow of ions as well as electrons. The dispensing end of the electrolyte reservoir may be brought into contact with the substrate to form the meniscus. When electrodeposition begins, the current in the electrolytic cell typically shows a sharp increase. This increase in current may be used as a signal to start increasing the separation of the reservoir and the substrate. Either or both the reservoir and the substrate may be moved; in an embodiment, the substrate is stationary and the reservoir is moved. Typically, there is a current stabilization or initialization period at the start of the electrodeposition process during which the current through the cell decreases from its initial value to a more constant value. Without wishing to be bound by any particular theory, this decrease in current is believed to be due to formation of a diffusion layer. The separation between the reservoir and the substrate will typically be increased during this phase of the electrodeposition process, but the current will typically show more variation than later in the process. In an embodiment, the stabilization period is less than 5 seconds.

To ensure that a meniscus is maintained between the electrolyte reservoir and the deposit, the withdrawal speed of the electrolyte reservoir relative to the substrate is maintained at a value within the theoretically-allowed range defined by the dynamic thermodynamic stability of the meniscus and the electrochemistry involved in the electrodeposition. In an embodiment, by setting the withdrawal speed of the electrolyte reservoir at a value within the theoretically-allowed range for stable growth, the growth of the deposit is self-regulated to a growth rate synchronized with the withdrawal speed of the electrolyte reservoir, the diameter of the deposited wire is self-regulated to a substantially constant diameter and the ionic current is also self-regulated to a substantially constant current.

In some embodiments of the invention, the current flow through the electrolytic cell will be substantially constant when the electrolytic reservoir is moved away from the substrate at an appropriate constant “pullback” speed (the withdrawal speed). As used herein, a substantially constant/stable current flow can include current variation within 15%, 10%, 5% or 2%. The theoretically-allowed speed range for the electrolyte reservoir can be estimated through the analysis of the thermodynamic stability of the meniscus confined between the nozzle and the deposit in conjunction with the analysis of the electrochemical deposition process as discussed in Example 3. The speed range can also be determined experimentally by varying the pullback speed and monitoring the ionic current until a stable ionic current is obtained at a constant potential difference. The process of determining a desirable pullback speed can be automated using a computerized control algorism. The pullback speed may be adjusted within the theoretically-allowed range during the current stabilization period. A pullback speed determined for a given set of experimental conditions may be suitable for identical or close to identical conditions. In an embodiment, the method for forming the elongated nanostructure comprises the steps of determining a speed of separation between the reservoir and the substrate which, when the electrical potential is maintained at a constant value, permits the electrical current between the reservoir electrode and the substrate to be maintained at a value which is constant to within 15% or 10% or 2%, and increasing the separation between the reservoir and the substrate at this previously determined speed.

In different embodiments, suitable pullback speed are 50 nm/sec-500 nm/sec, 50 nm/sec-250 nm/sec, 50-150 nm/sec, or 50 nm/sec-100 nm/sec. In an embodiment, the pullback speed used for deposition of platinum wires may be from 50-250 nm/sec. In an embodiment, the pullback speed used for deposition of copper wires may be from 150-500 nm/sec. In an embodiment, the electrolytic reservoir and the substrate are separated at a substantially constant “pullback” speed once electrodeposition has been detected. In another embodiment, the pullback speed is more gradually increased and then held at a substantially constant value. For example, the pullback speed may be increased in increments of 25 nm/sec or 50 nm/sec. In an embodiment, a substantially constant pullback speed can include variation within 15%, 10%, 5% or 2%.

If the reservoir is withdrawn from the substrate at higher velocities than those at which continuous and smooth deposition is obtained, the meniscus can break and growth may stopped. Alternately, if the pullback speed is only slightly too high, deposition of “beaded” wires may be obtained.

The electrical potential applied between the reservoir electrode and substrate may also be termed the bias voltage. For aqueous electrolyte solutions when the substrate is acting as the cathode, the bias voltage may be selected so that it is above the cathodic reduction potential but below the hydrolysis potential of water. It is believed that significant hydrogen bubble formation can agitate the meniscus and prevent stable electrodeposition. Suitable bias voltages to obtain reasonable rates of electrodeposition can be determined through analysis of a cyclic voltammetry (CV) plots.

The reservoir electrode may take various forms. In an embodiment, the reservoir electrode is a conducting wire inserted into the electrolyte solution. In another embodiment, the reservoir electrode can be a conducting element integral with the electrolyte reservoir (e.g. a conducting element made as part of a microfabricated reservoir).

The electrolyte reservoir comprises an aperture through which the electrolyte exits to form the meniscus (e.g. through making contact with the substrate). The aperture is connected to a lumen which allows flow of electrolyte through the reservoir. In an embodiment the electrolyte has two apertures located at opposite ends of the reservoir, a dispensing aperture and a filling aperture, with both apertures being connected by a lumen. In an embodiment of the methods of the invention, no external pressure is applied to the electrolyte to induce electrolyte flow through the dispensing end of the reservoir. In another embodiment, a pressure differential is applied to modify the size and/or shape of the meniscus formed. In an embodiment, this pressure differential is less than 10 psi, from 0.1-10 psi, from 1-10 psi, or from 1-5 psi (hydrostatic gauge pressure), and is smaller than the pressure that would be required to jet out the electrolyte from the dispensing end of the reservoir.

The size of the aperture at the dispensing end is selected to produce the desired lateral dimension of the structure; the aperture at the other end of the reservoir is usually larger to facilitate filling of the reservoir with electrolyte solution. The reservoir may be manually filled with electrolyte solution using a syringe inserted into the larger end of the reservoir, or by any other means known to the art. In an embodiment, the aperture at the dispensing end of the reservoir is less than 10 microns, less than or equal to 5 microns, less than or equal to 2 microns, less than or equal to one micron, less than or equal to 750 nm, less than or equal to 500 nm, less than or equal to 200 nm, less than or equal to 100 nm, less than or equal to 50 nm, less than or equal to 25 nm, from 100 nm to 10 microns, from 100 nm to 5 microns, between 50 and 750 nm, or between 100 and 750 nm. If the electrolyte wets the material of the electrolyte reservoir, the lateral dimension of the meniscus near the dispensing end of the reservoir will typically be larger than the inner diameter (aperture) at the tip of the dispensing end. For more complicated-shaped aperture, the equivalent aperture size may be approximated according to the area of the opening projected onto the growth plane.

In an embodiment, the electrolyte reservoir is a pipet having a dispensing aperture of the desired size. As used herein, the size of the aperture is the diameter of the opening. Typically, nanopipets are cylindrical capillary tubes which have a reduced tip diameter. Glass nanopipets having apertures of 500 nm, 200 nm and 100 nm are commercially available. Electrolyte reservoirs with aperture sizes less than 100 nm, such as 50 nm, may also be suitable for use with the invention.

In an embodiment, multiple electrolyte reservoirs may be used to simultaneously deposit multiple structures. In an embodiment, an array of nanostructures can be formed.

As used herein, an electrolyte solution is a solution comprising an ionic component and an ionic liquid. Suitable active ionic components include metal ions, ions useful in forming compound semiconductors or conducting or semiconducting oxides and monomers or polymers which contain ionic groups or which can be treated to form ionic groups. As used herein, an active ionic component is an ionic component that can participate in an electrochemical reaction. In an embodiment, the ionic component is an ion of a metal such as copper or platinum. In other embodiment, the ionic component is a monomer such as oxidized pyrrole or aniline. In other embodiment, a plurality of ionic components are used, such as a combination of Cd²⁺ and S₂O₃²⁻ to deposit CdS. The ionic component may be formed by dissociation of an electrolyte in an electrolyte solvent. The electrolyte solution further comprises a solvent. Suitable solvents depend on the nature of the ionic component. In an embodiment, the solvent is water and the solution is aqueous. The electrolyte can also comprise additional components such as additives and acid. In an embodiment, the concentration of the ionic component is varied according to the size of the wire to be deposited and the type of ionic component used for the deposition. In an embodiment, the concentration of the ionic component is from 0.001 M to 1 M, from 0.005 to 1 M, from 0.001 M to 0.5 M, from 0.005 to 0.5 M, or from 0.001 M to 0.1 M.

In an embodiment when the electrolyte solution is an aqueous solution, both the inner and outer surfaces of the dispensing end of the reservoir may be hydrophilic or the inner surface may be hydrophilic with the outer surface being hydrophobic.

The evaporation of electrolyte near the dispensing end of the electrolyte reservoir, which is exposed to ambient (i.e. gaseous or non-liquid) environment, tends to form crystallites on the tip that can block the aperture and thus prevent further deposition. For aqueous solutions, the humidity of the adjacent environment can be controlled to limit or prevent the crystallization of the solute near the tip. In different embodiments, the humidity is greater than or equal to 20% and less than or equal to 80%, from 20% to 70%, between 30% and 50%, between 40% and 60% or about 50%. Beyond controlling the humidity to prevent clogging of the dispensing aperture, within the allowable range, humidity can also be used as an adjustable parameter to regulate the ionic concentration of the electrolyte within or immediately near the meniscus and thus affect the electrodeposition. Similarly, for nonaqueous solutions the vapor pressure of the solvent can be controlled to limit clogging of the tip.

The concentration of the electrolyte solution affects the rate of electrodeposition, with higher concentrations of the ionic component typically producing higher ionic currents. However, higher electrolyte concentrations can also lead to increased evaporation-induced clogging of the tip.

In an embodiment, the electrodeposited material is polycrystalline. The electrodeposited material can also be of a single crystal. It is believed single-crystal formation in electrochemical deposition is preferred when the growth of the initial nuclei is faster than the formation of new nuclei. Use of lower electric potentials, higher temperatures, and the absence of additives may encourage formation of single crystals.

The substrate is sufficiently electrically conducting at the deposition location to allow it to act as an electrode. Electrical conductivity may be provided by an electrically conducting coating; the whole of the substrate need not be electrically conducting. In one embodiment, the substrate may be essentially flat and planar. In another embodiment, the substrate is non-planar. For example, the substrate may be the tip of a conductive scanning microscopy probe.

The invention also provides suitable apparatus for performing the electrodeposition methods of the invention. The apparatus comprises at least one electrolyte reservoir and at least one reservoir electrode.

In an embodiment, the apparatus also includes at least one process control system which allows monitoring and control of both the current through the electrochemical cell and the relative motion of the electrolyte reservoir and the substrate. The system enables closed loop control of the deposition current. The process control system is operably connected to both a device for measuring the current flow through the electrochemical cell and at least one motion control device. In an embodiment, the process control system comprises a computer program capable of data acquisition and motion control and a data acquisition card. The software program can control the rate of separation of the reservoir and the substrate so that electrical current is maintained between these two elements. As an example, LabVIEW software (National Instruments) may be used to control this aspect of the electrodeposition process.

The apparatus includes at least one motion control device operably connected to the reservoir and/or the substrate or a substrate holder. The motion control device provides for adjustment of the relative positions of the reservoir and substrate during the course of electrodeposition. In particular, the motion control device allows control of the separation of the reservoir and substrate in the direction perpendicular to the face of the substrate at the deposition location (the z direction). In an embodiment, the position of at least one of the electrolyte reservoir or substrate is controlled by a motion-control stage. If the substrate position is controlled by the motion-control stage, the platform of the stage will typically provide the substrate holder. In an embodiment, the reservoir is attached to one or more stages which allow precise control of motion along x, y, and z directions. Coarse motion in x, y, and z directions may be provided by one type of stage and fine motion by another type of stage, as is known to those skilled in the art. Suitable stages for this purpose are also known to those skilled in the art and include, but are not limited to, combinations of Burleigh inchworm stages and piezodriven flexure stages. The relative motion of the substrate and the reservoir is controlled so that the motion is not jerky. In an embodiment, the step size is smaller than 100 nm/s. In another embodiment, the piezoelectric stage(s) has/have a nominal resolution of less than 10 nm. The piezoelectric stages may be long range stages. The quality of motion control can be improved by using smaller step sizes, a better voltage source for driving the piezoelectric stage and better vibration isolation.

The apparatus also includes a source of electrical potential electrically connected to the reservoir and the substrate so as to apply a potential difference between the reservoir electrode and the substrate. Any suitable source of direct current electrical potential known to those skilled in the art can be used. In an embodiment, the source of electrical potential is a power supply. In an embodiment, the allowed variation in the bias voltage for “constant” bias voltage is less than 2%.

The apparatus also includes a device for measuring the flow of ionic current in the electrochemical cell or the electrical current through the external portion of the cell. This current may be measured by any suitable current measuring device known to the art, including an electrometer. The quality of the ion current sensing is affected by the noise performance of the electrometer. In an embodiment, the electrometer circuit has a resolution of less than 1 pA. In an embodiment, the ionic current may be controlled in the range of 1 nA to 500 nA, 1 nA to 100 nA or 1 nA to 50 nA.

Both the electrolyte reservoir and substrate may be placed in an enclosure to enable humidity control of the atmosphere surrounding the reservoir and substrate. The enclosure may have an inlet to which a humidifier may be connected. A heating device, such as a resistive heater, may be placed inside the enclosure to assist in controlling the temperature at which electrodeposition occurs.

An integrated optical microscope system may be incorporated into the apparatus to provide an optical resolution view of the sample. The optical microscope system can facilitate alignment of the electrolyte reservoir with respect to the substrate.

A vibration isolation device may also be used to improve control of the process. The vibration isolation device is adapted to limit vibration of the substrate, the electrolyte reservoir and typically the motion control device as well. Suitable vibration isolation devices include, but are not limited to, vibration isolation tables.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

Whenever a range is given in the specification, for example, an electron dosage range or a time range, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

One skilled in the art would readily appreciate that the present invention is well adapted to carry out the objects and obtain the ends and advantages mentioned, as well as those inherent therein. The methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

All references cited herein are hereby incorporated by reference to the extent not inconsistent with the disclosure herewith. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a method is claimed, it should be understood that compounds known in the prior art, including certain method disclosed in the references disclosed herein (particularly in referenced patent documents), are not intended to be included in the claim.

Although the description herein contains many specificities, these should not be construed as limiting the scope of the invention but as merely providing illustrations of some of the presently preferred embodiments of the invention. For example, thus the scope of the invention should be determined by the appended claims and their equivalents, rather than by the examples given.

The invention may be further understood by the following non-limiting examples.

### Example 1

### Fabrication of Nanostructures

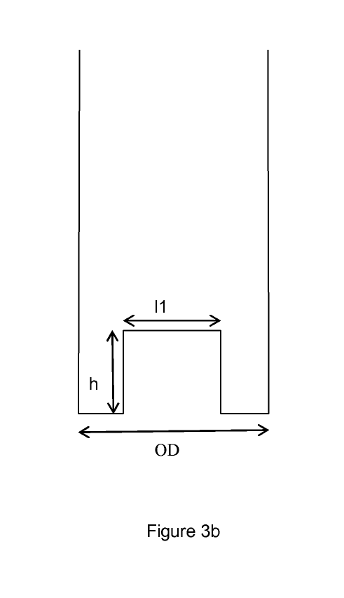

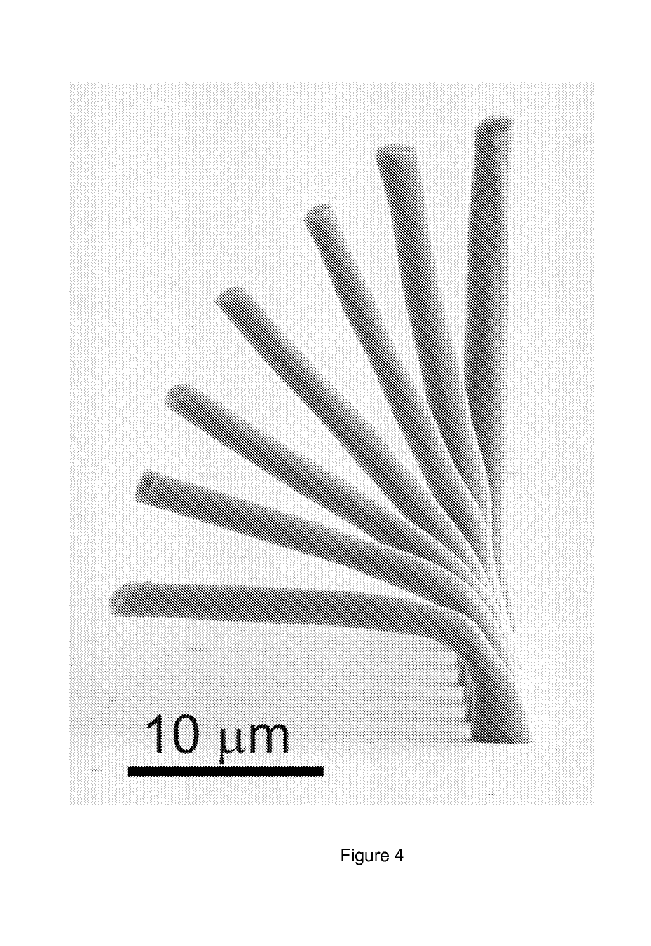

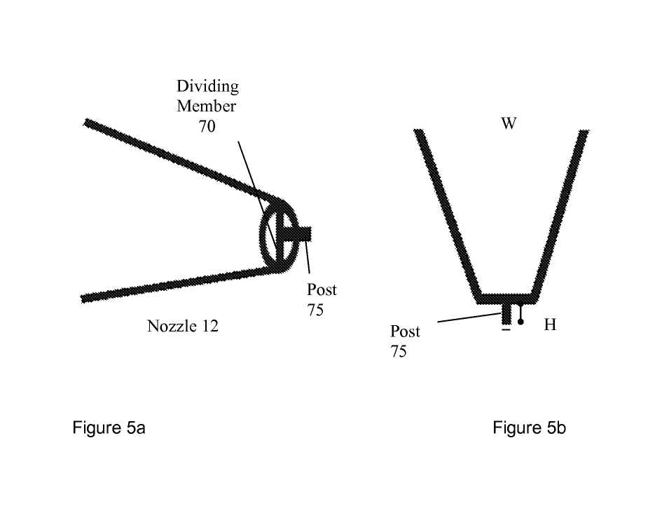

FIG. 4 shows a series of angled Cu wires grown with a side-cut nozzle as shown in FIG. 3a. The vertical and lateral lengths as well as the orientation of the Cu wires were controlled by the travel path of the micropipette, and the diameter determined by the nozzle size and the size of the side opening in the nozzle. To fabricate these structures, a micropipette filled with a simple 0.05 M CuSO₄ aqueous solution with no other additives was used and biased at 0.2 V with respect to the Au-coated sample surface. The micropipette had a nozzle diameter of ˜3 μm and had a side cut made with the focused ion beam machining. The growth rate for the Cu wire at those conditions was ˜0.25 μm/s, and the corresponding ionic current was maintained at ˜3.5 nA. The deposition was carried out with the substrate exposed to a humidity controlled ambient air environment at room temperature.

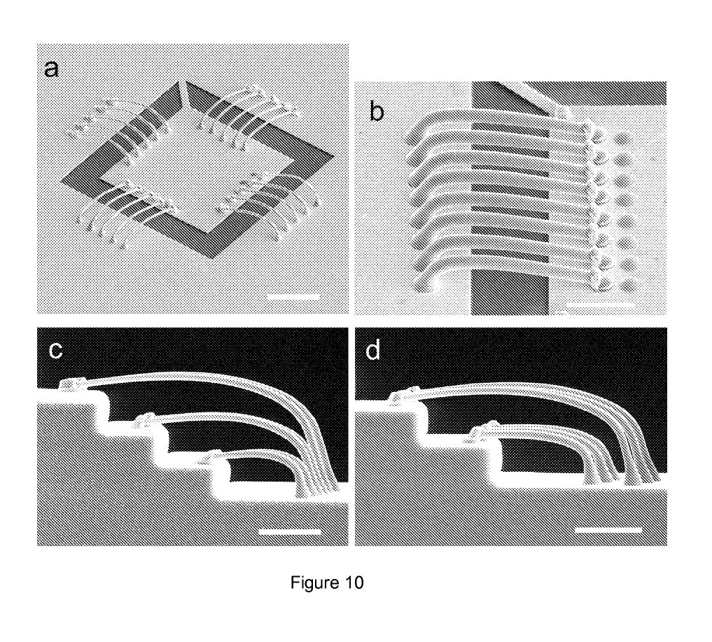

FIGS. 9A-D illustrates various structures made using meniscus-confined electrodeposition for the fabrication of 3-D structures and needle probes using regular micropipettes without a micromachining-shaped notch. (A) SEM image showing the side view of a Cu coil having a wire diameter of ˜1.6 ˜m, a coil diameter of ˜7 μm and a pitch of ˜17 μm fabricated with the use of a micropipette having a nominal nozzle diameter of ˜2 μm. (B) SEM image showing the top view of the same Cu coil in (A). (C) SEM image showing the side view of a Cu coil having a wire diameter of ˜300 nm, a coil diameter of ˜800 nm and a pitch of ˜3.8 μm. (D) SEM image showing a Pt needle directed deposited on the apex of an atomic force microscope probe tip. The Pt needle has a diameter of ˜80 nm and a length of ˜1.2 μm.

### Example 2

### Interconnect Bridge Fabrication

To facilitate the interconnect bridge fabrication with a method that involves the lateral growth of a metallic wire over a sufficient span, the micropipette nozzle was shaped to allow additionally the stable meniscus formation sideway to the nozzle during the lateral growth of metallic wire. FIG. 3a shows a typical shaped micropipette nozzle having a nozzle diameter of about 3 μm. Micropipettes having other nozzle diameters can also be shaped depending on the size of the wire to be fabricated. For fabricating Cu wire bonds, typically a simple 0.05 M CuSO₄ aqueous solution with no other additives was used and filled into a micropipette and biased at 0.2 V with respect to the conductive sample surface. The deposition was carried out with the substrate exposed to a humidity controlled ambient air environment at room temperature.

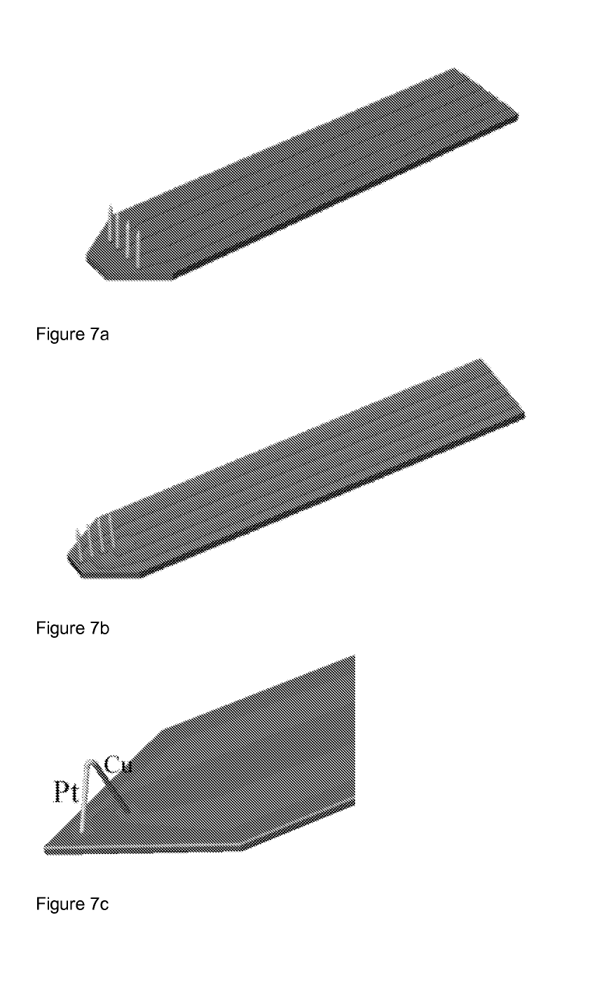

To complete a wire bonding process (as schematically described in FIGS. 6a-d), the second bond was formed by mechanically pushing the suspended end of the laterally-grown metal wire down to the substrate with the nozzle end to a close proximity so that the electrolyte meniscus under the nozzle extended to immerse both the wire end and the region of contact on the substrate surface. Several voltage pulses having amplitude set above the electrodeposition potential were then applied to initiate the electrodeposition within this extended meniscus to join the wire end and the substrate. The distance needed to push the wire end towards the surface was determined by an automated sensing procedure in which the micropipette was slightly shifted sideway to detach from the wire end and driven with the piezoelectric stage to approach the substrate surface with the electrolyte biased at a deposition potential. At the moment of the meniscus formation between the nozzle and the substrate surface, an instant ionic current could be detected and the distance between the wire end and the underlying substrate surface was thus exactly determined. The micropipette was then withdrawn back to re-engage with the wire end to perform the second bond as described.

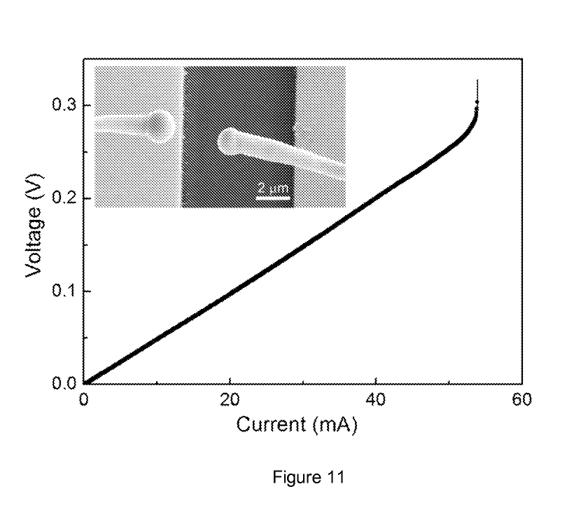

FIG. 10a-10d shows the result of this electrodeposition-based wire bonding of submicron diameter Cu wires. The wire bonding process was performed to form 20 interconnects fanning out from a central 50 μm×50 μm bonding pad, resembling the typical device layout in device packaging (FIG. 10a). Multilayered interconnection without (FIG. 10c) or with (FIG. 10d) overlap wiring was also realized. The diameter of the Cu wires (in FIGS. 10a, c and d) is about 800 nm, and the size of the formed bonds is about 3 μm, both are an order of magnitude smaller than the sizes in the current industrial practice. The scale bar shown in FIGS. 10a-10d is 10 micrometers.

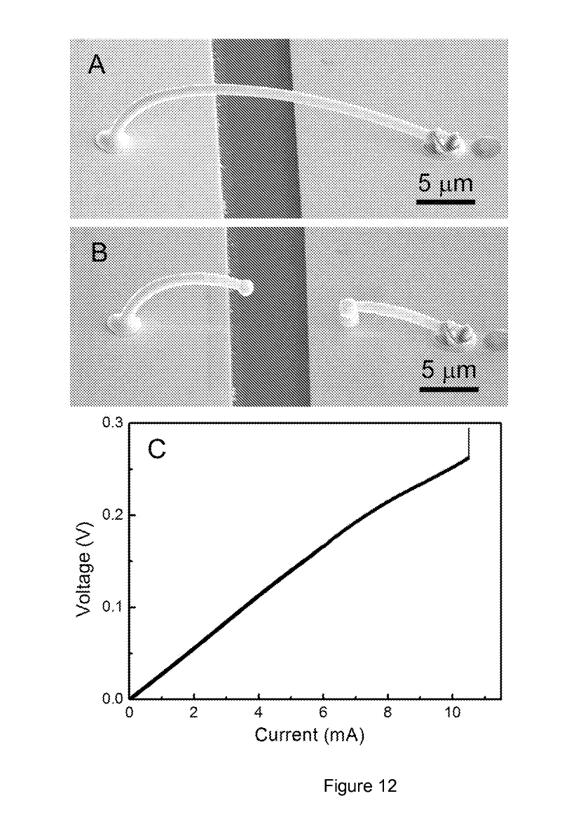

The bonded wires were found to be of high electrical quality. FIG. 11 shows the acquired I-V curve from a bonded Cu wire having a diameter of ∞740 nm and a length of ˜40 μm and tested in an ambient air environment. The linear behavior in the broad current range reflected the Ohmic contact property of the bonds. The nonlinear behavior at high current implied the potential effect of heating (thus oxidation of the Cu wire) (24). The overall resistance of the bonds and the wire was ˜2.9 Ω when deducting the resistance contributed from the peripheral connections in the measurement, very close to the expected value for a Cu wire of this size (˜1.6 Ω assuming an electrical resistivity of 1.68×10⁻⁸ m of bulk Cu) with the bonds contributing a small contact resistance. At high current, the bonded Cu wire failed in the middle of the bridge and not at the bonds. The breakdown current density determined from the breakdown current is −1.25×10¹¹ A/m², agreeing with the reported values for similar size Cu wires (25-27). Mechanically, the bonding strength of the bond formed by the electrodeposition was measured with an AFM cantilever-based pull test. By monitoring the deflection of the AFM cantilever while pulling a Cu wire vertically grown on a Au-coated substrate through the free end glued onto the AFM tip with epoxy, we calculated that the strength of this electrodeposition-formed bond was over ˜39 MPa, well above the nominal bonding strength required in a traditional wire bonding (8.5 MPa according to the MIL-STD-883G test standard).

As in a regular wire bonding process, certain mechanical analyses are typically considered in order to design such small interconnect bridges. One is the stress sustained by the wire in this particular fabrication process, which should ideally be below the stress that can mechanically fail the metal wire; and the other is the spring force sustained by the second bond, which should be lower than the bonding force. Consider a simple geometry of the interconnect bridge as shown in FIG. 6, the maximum stress occurs at the right edge of the 90° bend and can be estimated according to φ_{c}=3EHr/L², and the spring force sustained by the second bond according to Fₛ=3πEHr⁴/4L³, where E is the Young's modulus of the metal wire, H is the standoff height, L and r are the length and radius of the lateral segment of the wire. For a typical Cu interconnect bridge of 1 μm in wire diameter, 5 μm in standoff height and 30 μm in span, the maximum stress is calculated to be ˜1 GPa, which is beyond the yield strength of Cu, meaning that the Cu wire at the bend will experience a plastic deformation in the bonding process. The problem can be readily solved (if needed) by growing a tilted wire from the first bond instead of a vertical one to allow the formation of a smooth bend instead of a 90° bend. The spring force on the second bond is ˜3 μN, and when taking 10 μm² as the size of the second bond, the loading stress is around 0.3 MPa, much lower than the debonding strength we measured for such electrodeposited bond. Overall, reducing the wire diameter and increasing the lateral length of the wire can also effectively benefit the lowering of such stresses.

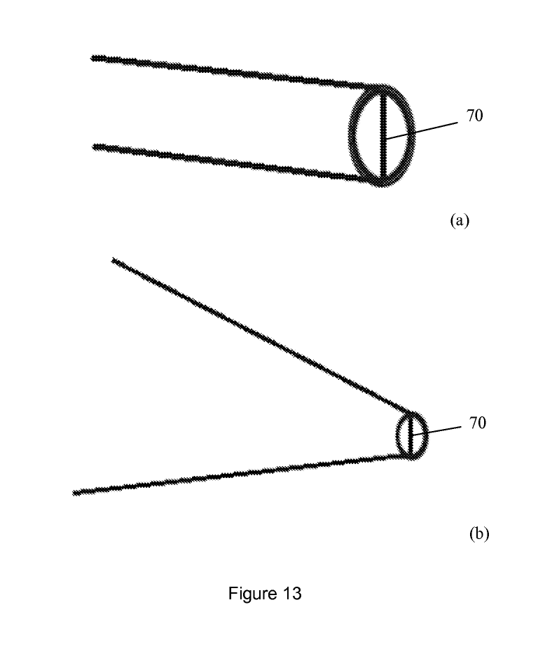

Fabrication and characterization have also been carried out for Pt interconnects deposited with the use of an aqueous solution of chloroplatinic acid (H₂PtCl₆) as the electrolyte. Similar results were obtained (see FIG. 12A-12C).

Also see J. Hu and M. -F. Yu, Science, 329, 313 (2010), hereby incorporated by reference.

### Example 3

### Meniscus Stability Calculations

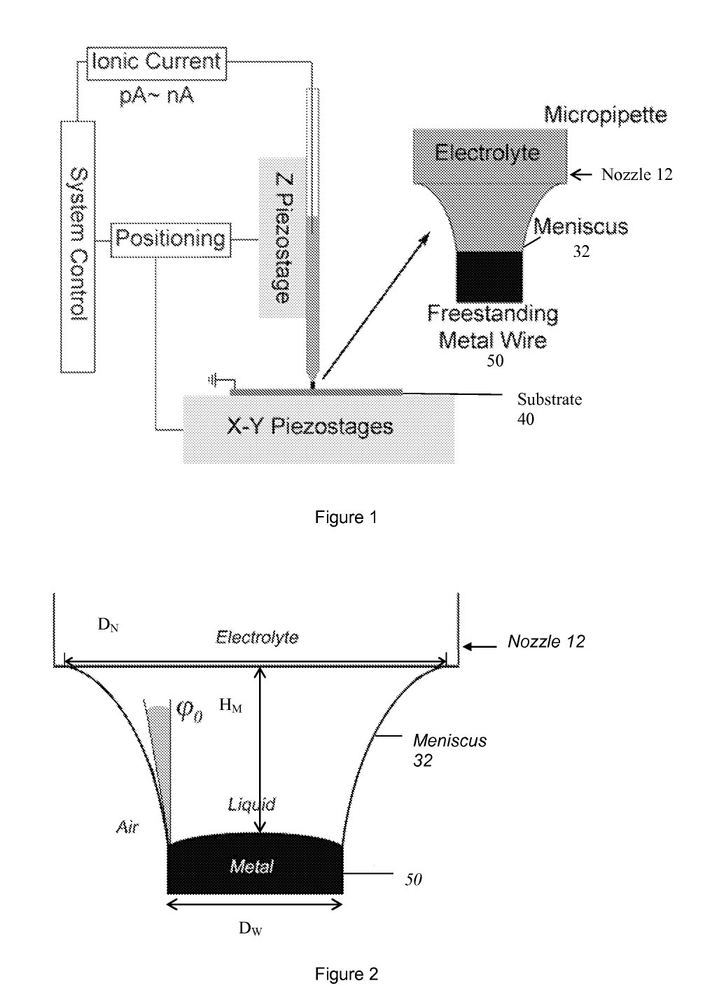

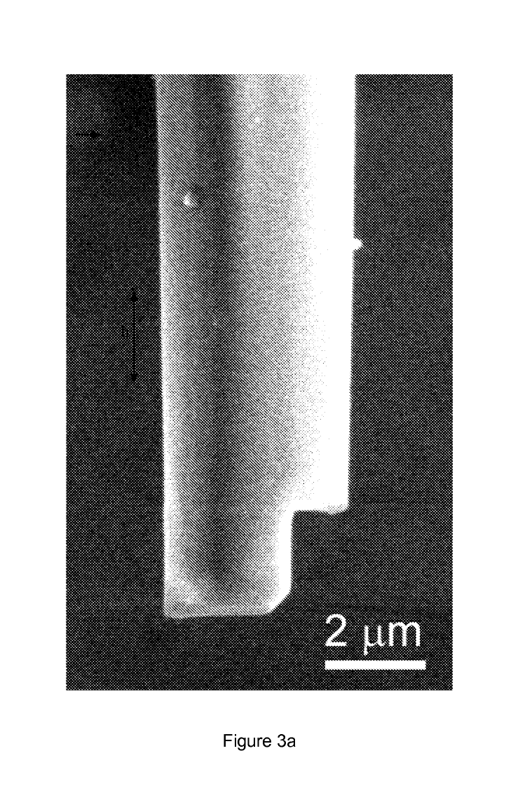

To maintain the growth of a uniform diameter wire, the thermodynamic consideration of the interfacial forces at the three-phase contact line between the meniscus and the growing wire requires the classical Neumann quadrilateral relation to be met(18), which would then require the establishment of an equilibrium angle φ₀ between the growth direction and the slope of the meniscus at the contact line (as shown in the inset in FIG. 1 and in FIG. 2):

φ₀=arccos[γ_{L}²+γ_{S}²−γ_{SL}²)/2γ_{L}γ_{S}], (1)

Where γ_{L} and γ_{S} are the surface energies of the electrolyte and the metal wire and γ_{SL} is the interfacial energy of the metal/liquid interface. This angle is determined to be ˜12° for the copper-water-air system (taking γ_{L}=0.07119 J/m², γ_{S}=0.71±0.18 J/m², γ_{SL}=0.01456 J/m²)(19, 20). Solving the meniscus shape equations then defines that there exists a region of stability for the stable growth of a uniform diameter wire governed by (21):

$$\frac{{H}_{M}}{{D}_{W}} = \frac{1}{2} cos {ϕ}_{0} [ {cosh}^{- 1} \frac{{D}_{N}}{{D}_{W} cos {ϕ}_{0}} - {cosh}^{- 1} \frac{1}{cos {ϕ}_{0}} ] , \qquad ( 2 )$$

Where H_{M} is the height of the meniscus, D_{N} is the diameter of the micropipette nozzle and D_{W} is the wire diameter. For a micropipette having a nozzle diameter of D_{N}, the allowed diameter of the wire that can be stably grown lies within D_{N} to ˜0.5D_{N}. Within the stable growth region, the deviation of the contact angle φ from the equilibrium angle φ₀ leads to the fluctuation of the wire size according to:

$$\frac{d {D}_{W}}{d t} = 2 ( {v}_{N} - {v}_{W} )$$

tan δφ, where ν_{N} is the withdrawal speed of the micropipette and ν_{W} is the growth rate of the wire. The growth rate of the wire is simply defined by the Faraday's law:

$${v}_{W} = \frac{4 iM}{{neN}_{A} ρ π {D}_{W}^{2}} ,$$

where i is the electrodeposition current, M and ρ are the molar mass and the mass density of the deposited material, respectively; n is the number of electrons per ion and N_{A} is the Avogadro's number. FIGS. 8a and 8b show the experimentally acquired parameter window for the stable growth of wire in terms of the resulted wire diameter, the withdrawal speed and the applied ionic current, in comparison to the prediction from the described model. In the modeling, the diameter of the nozzle was exactly measured from the scanning electron microscopy image and the surface energy and interfacial energy values for the Cu-water-vapor system were obtained from literatures. The experimentally observed decrease in wire diameter with increasing withdrawal speed generally corresponds to that predicted by the model, although the observed allowed range of withdrawal speeds is smaller than predicted by the model for these conditions. The ends of the solid curve from the model represent the limits of wire growth, out of these limits, no stable growth is allowed. Such stability and plasticity in meniscus afforded a robust process needed for the fabrication of interconnect bridges as demonstrated in this study.

### Example 4

### Formation and Use of Omni-Directional Deposition Probe

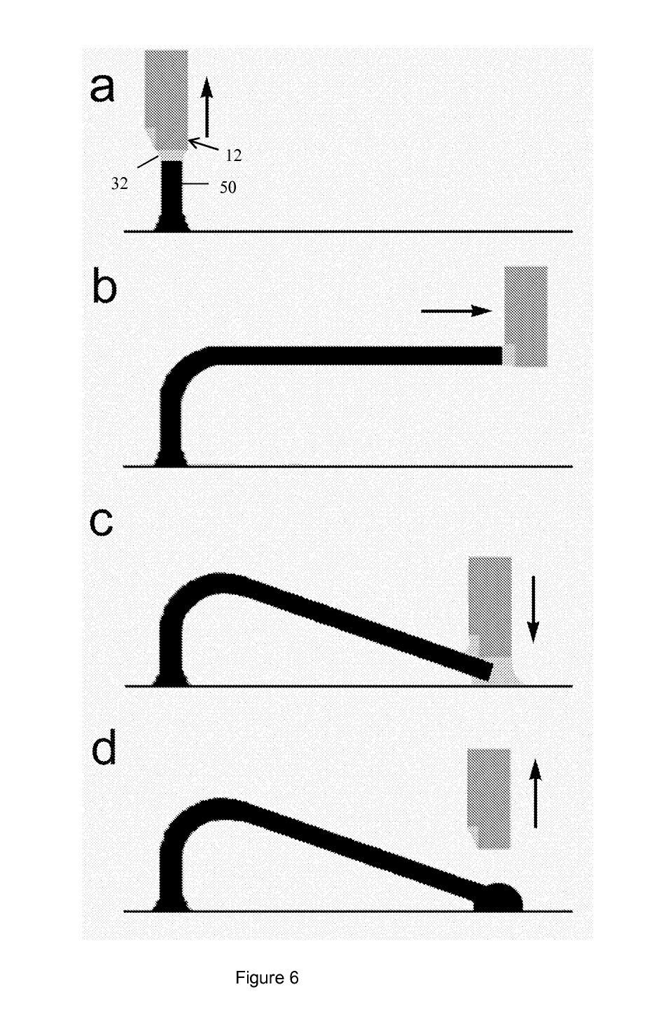

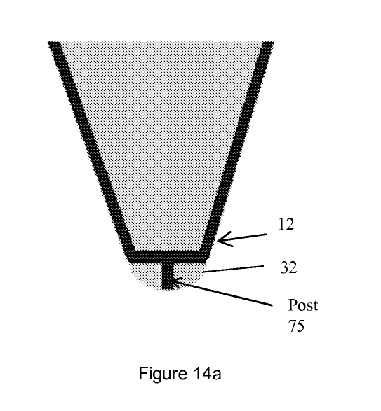

Procedure for formation of probe illustrated in FIGS. 5a-b: 1) Use a pipette puller to pull a theta glass tube (FIG. 13a) to make a theta micropipette (FIG. 13b). 2) Use a focused ion beam to shape the micropipette into a nozzle having a center post (FIGS. 5a-b).

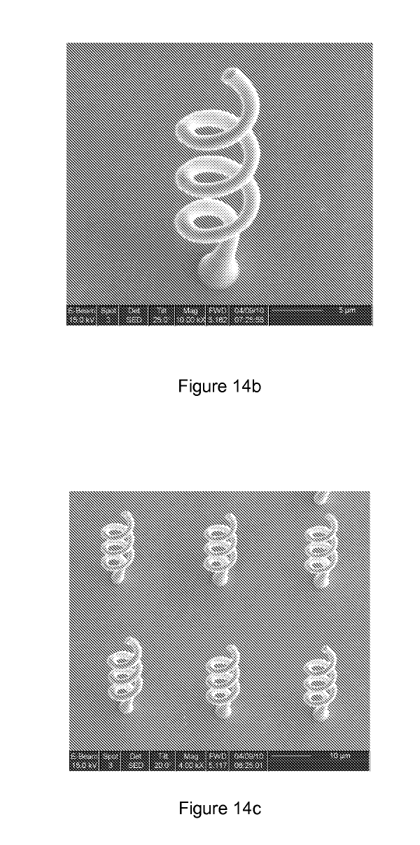

Use of Omni-Directional Probe: 1) Fill the theta-micropipetter with the center post at the nozzle with the electrolyte used for the electrodeposition 2) Apply a static pressure of several psi through the micropipette to form a hemispherical liquid droplet at the nozzle (FIG. 14a).The hemispherical shaped droplet facilitates the meniscus formation in all forward and lateral directions in the meniscus-confined electrochemical deposition. FIG. 14b illustrates a coil fabricated using this probe; the coil has a significantly smaller pitch than the coils of similar size fabricated with the regular micropipettes without the micromachining-shaped nozzle. Arrays of such coils can also be fabricated (FIG. 14c).

References

1. P. Ramm, J. M. Wolf, B. Wunderle, in 3-D IC Integration: Technology and Applications P. E. Garrou, P. Ramm, C. A. Bower, Eds. (Wiley-VCH, New York, 2008).

2. G. Harman, Wire Bonding in Microelectronics (McGraw-Hill, New York, 2009).

3. C. Harper, Electronic Packaging and Interconnection Handbook (McGraw Hill, New York, 2005).

4. International Technology Roadmap for Semiconductors (ITRS-2007).

5. T. Morita, R. Kometani, K. Watanabe, K. Kanda, Y. Haruyama, J. Vac. Sci. Technol. B 21, 2737 (2003).

6. B. Y. Ahn et al., Science 323, 1590 (2009).

7. C. R. Martin, Science 266, 1961 (1994).

8. M. E. Toimil Molares, V. Buschmann, D. Dobrev, R. Neumann, R. Scholz, I. U. Schuchert, and J. Vetter, Adv. Mater. (Weinheim, Ger.) 13, 62 (2001).

9. M L. Tian, J. U. Wang, J. Kurtz, T. E. Mallouk, and M. H. W. Chan, Nano Lett. 3, 919 (2003).

10. M. P. Zach, K. H. Ng, and R. M. Penner, Science 290, 2120 (2000).

11. J. D. Madden and I. W. Hunter, J. Microelectromech. Syst. 5, 24 (1996).

12. R. A. Said, Nanotechnology 15, 649 (2004).

13. F. Iwata, Y. Sumiya, and A. Sasaki, Jpn. J. Appl. Phys., Part 2 43, 4482 (2004)

14. A. P. Suryavanshi, M. -F. Yu, Appl. Phys. Lett. 88, 083103 (2006).

15. A. P. Suryavanshi, M. -F. Yu, Nanotechnology 18, 105305 (2007).

16. Y. Li, B. W. Maynor, J. Liu, J. Am. Chem. Soc. 123, 2105 (2001).

17. R. Defay, I. Prigogine, Surface Tension and Adsorption (Longman, London, 1966).

18. M. Seo, I. Sawamura, L. Grasjo, Y. Haga, N. Sato, J. Soc. Mater. Sci. Jpn 39, 357 (1990).

19. H. Ghasemi, C. A. Ward, J. Phys. Chem. C 114, 5088 (2010).

20. Y. A. Tatarchenko, Shaped Crystal Growth (Kluwer Academic, New York, 1993).

21. J. Jang, G. C. Schatz, M. A. Ratner, Phys. Rev. Lett. 92, 085504 (2004).

22. J. Jang, G. C. Schatz, M. A. Ratner, Phys. Rev. Lett. 90, 156104 (2003). 23. R. C. Major, J. E. Houston, M. J. McGrath, J. I. Siepmann, X.-Y. Zhu, Phys. Rev. Lett. 96, 177803 (2006).

24. M. E. T. Molares et al., Appl. Phys. Lett. 82, 2139 (2003).

25. Q. Huang, C. M. Lilley, M. Bode, R. Divan, J. Appl. Phys. 104, 023709 (2008).

26. Q. Huang, C. M. Lilley, R. Divan, Nanotechnology 20, 075706 (2009).

27. S. Karim, K. Maaz, G. Ali, W. Ensinger, J. Phys. D: Appl. Phys. 42, 185403 (2009).

28. J. Hu and M. -F. Yu, Science, 329, 313 (2010)

1. A method for forming a wire bond between a first and a second contact site, the wire of the bond being of a selected material, the method comprising the steps of:
a. providing an electrolyte reservoir having a dispensing end, the dispensing end comprising a peripheral structure surrounding an aperture, the dispensing end being shaped to allow off-surface wire formation in a lateral direction as well as in a vertical direction with respect to the first contact site and the size of the aperture being less than or equal to 10 micrometers, the reservoir containing
i) an electrolyte solution comprising at least one ionic component and
ii) a reservoir electrode in electrical contact with the electrolyte solution;
b. applying a potential difference between the reservoir electrode and the first contact site, with the first contact site working as the cathode and the reservoir electrode as the anode;
c. bringing the aperture of the electrolyte reservoir to a first position sufficiently close to the first contact site to establish a meniscus (a liquid bridge) between the dispensing end of the reservoir and the first contact site, thereby establishing a volume of electrolyte solution external to the reservoir between the dispensing end of the reservoir and the first contact site and to establish an ionic current between the reservoir electrode and the first contact site, thereby reducing the ionic component or components in the electrolyte to electrodeposit the selected material at the first contact site;
d. selecting a first trajectory for moving the electrolyte reservoir from the first position to a second position directly above the second contact site, the first trajectory having both a lateral and a vertical component with respect to the first contact site;
e. moving the reservoir along the first trajectory at a speed selected to maintain a stable meniscus formation and sustain a continuous electrodeposition to grow a wire of the selected material following the first trajectory;
f. contacting the end of the wire with the dispensing end of the reservoir;
g. selecting a second trajectory for moving the electrolyte reservoir from the second position to a third position sufficiently close to the second contact site to establish a meniscus between the dispensing end of the reservoir and the second contact site;
h. moving the reservoir along the second trajectory while maintaining physical contact between the wire and the dispensing end, thereby pushing the wire towards the second contact site;
i. forming a meniscus between the dispensing end of the reservoir and the second contact site, thereby forming a volume of electrolyte solution external to the reservoir between the dispensing end of the reservoir and the second contact site, wherein the wire is in contact with this volume of electrolyte solution but not in contact with the second contact site; and
j. applying a potential difference between the reservoir electrode and the second contact site with the second contact site as a cathode and the reservoir electrode as an anode, thereby reducing the ionic component to electrodeposit the conductive material at the second contact site and fusing the wire to the second contact site.

2. The method of claim 1, wherein the peripheral structure at the dispensing end of the electrode includes at least one notch, the notch being positioned to permit lateral growth of the wire.

3. The method of claim 1 wherein the dispensing end further comprises a support member at least partially spanning the aperture and a central member connected to the support member at a first end, the other end of the central member extending beyond at least a portion of the peripheral structure.

4. The method of claim 1, wherein a hydrostatic gauge pressure of 0.1-10 psi is applied to the electrolyte within the reservoir.

5. The method of claim 1, wherein a plurality of voltage pulses are applied in step i in claim 1 to fuse the wire to the second contact site.

6. The method of claim 1, wherein the electrolyte solution is an aqueous solution and the method further comprises the step of controlling the humidity surrounding the electrolyte reservoir and the first and second contact sites, the humidity being from 20% to 80%.

7. The method of claim 1 wherein the average wire diameter is from 0.1 micrometer to 10 micrometers.

8. The method of claim 1 wherein the average wire diameter is from 0.1 micrometer to 1 micrometer.

9. The method of claim 1 wherein the first contact site is on one electronic device or a contact lead and the second contact site is on another electronic device or a contact lead.

10. The method of claim 1, wherein the selected material is a metal or a metal alloy and the ionic component is an ion or ions electrochemically associated with the metal.

11. A method for forming an elongated structure of a selected material, the structure extending at least partially upwards from a structure, the method comprising the steps of:
a. providing an electrolyte reservoir having a dispensing end, the dispensing end comprising a peripheral structure surrounding an aperture, the dispensing end being shaped to allow wire formation in a lateral direction as well as in a vertical direction with respect to the substrate and, the size of the aperture being less than or equal to 10 micrometers, the reservoir containing
i. an electrolyte solution comprising at least one ionic component; and
ii. a reservoir electrode in electrical contact with the electrolyte solution;
b. applying a potential difference between the reservoir electrode and an electrically conducting substrate with the substrate as a cathode and the reservoir electrode as an anode;
c. bringing the aperture of the electrolyte reservoir to a first position sufficiently close to substrate to establish a meniscus between the dispensing end of the reservoir and the substrate, thereby establishing a volume of electrolyte solution external to the reservoir between the dispensing end of the reservoir and substrate, and sufficiently close to establish an ionic current between the reservoir electrode and the substrate, thereby reducing the ionic component or components in the electrolyte to electrodeposit the selected material at the substrate;
d. selecting a trajectory for moving the electrolyte reservoir from the first position to a second position, the trajectory having both a lateral and a vertical component with respect to the substrate; and
e. moving the reservoir along the first trajectory at a speed selected to maintain a stable meniscus and sustaining a continuous electrodeposition to grow a wire of the selected material following the trajectory.

12. The method of claim 11, wherein the elongated structure is a coil having a pitch from 0.5 micrometer to 100 micrometers.

13. The method of claim 11, wherein the elongated structure is a zigzag antenna having a period from 1 micrometer to 100 micrometers.

14. The method of claim 11, wherein the elongated structure is a meander antenna having a period from 1 micrometer to 100 micrometers.

15. The method of claim 11, wherein the elongated structure is a loop antenna having a radius from 1 micrometer to 100 micrometer.

16. The method of claim 11, wherein the average diameter of the wire forming the structure is from 0.1 micrometers to 10 micrometers.

17. An electrolyte reservoir comprising a dispensing end having a longitudinal axis and comprising a peripheral portion surrounding an aperture, the peripheral portion being in the form of a hollow cylinder including a notch, wherein the outer diameter of the cylinder is from 500 nanometers to 10 micrometers, the height of the notch is from 0.1 to 1.5 times the cylinder outer diameter, and the minimum width of the notch is from 0.1 to 0.75 times the cylinder outer diameter.

18. The electrolyte reservoir of claim 17, wherein the outer diameter of the cylinder is from 500 nm to 5 micrometers.

19. The electrolyte reservoir of claim 17, wherein the height of the notch is from 0.5 to 1.5 times the cylinder outer diameter.

20. An electrolyte reservoir comprising a dispensing end having a longitudinal axis, the dispensing end comprising
a) a peripheral portion surrounding an aperture, the peripheral portion being in the form of a hollow cylinder or graduated hollow cylinder;
b) a support member at least partially spanning the aperture; and
c) a central member having a height (H) and being connected to the support member at a first end, the other end of the central member extending beyond at least a portion of the peripheral portion of the dispensing end
wherein the outer diameter of the cylinder is from 500 nanometers to 10 micrometers and the height of the central member is less than or equal to the outer diameter of the cylinder.

21. The electrolyte reservoir of claim 20, wherein the outer diameter of the cylinder is from 500 nm to 5 micrometers.

22. The electrolyte reservoir of claim 20 wherein the height of the central member is from 0.5 to 1.0 times the outer diameter of the cylinder.

23. A metallic wire bond between a first and a second contact point, wherein the wire bond comprises:
a) a central portion, the central portion having a diameter which is uniform to within +/−15% the average diameter of the central portion being from 0.1 micrometer to 10 micrometers
b) a first end portion connected to one end of the central portion and to the first contact point, wherein the diameter of the first end portion generally decreases from 1 to 5 times the diameter of the central portion at the first contact point to the diameter of the central portion at the connection to the central portion, the length of the first end portion being from 1 to 5 times the diameter of the central portion; and
c) a second end portion connected to the other end of the central portion and to the second contact point, wherein the average diameter of the second end portion is larger than the diameter of the central portion and the height of the second end portion is from 1 to 5 times the diameter of the central portion.

24. The wire bond of claim 23, wherein the wire bond is of copper, gold, platinum, palladium, or alloys thereof.

25. The wire bond of claim 23, wherein the average diameter of the central portion is from 0.1 micrometer to 1 micrometer.

26. The wire bond of claim 23, wherein the average diameter of the second end portion is from 2 to 5 times the diameter of the central portion.

27. An electronic device comprising the wire bond of claim 23.
